(19) United States
(12) Patent Application Publication
(10) Pub. No.: US 2025/0075089 A1
(43) Pub. Date: Mar. 6, 2025

(54) INK JET RECORDING METHOD, INK JET RECORDING APPARATUS, AND LIQUID COMPOSITION

(71) Applicant: CANON KABUSHIKI KAISHA, Tokyo (JP)

(72) Inventors: KAZUYA NUSHIRO, Tokyo (JP); TOMOHIRO YAMASHITA, Kanagawa (JP)

(21) Appl. No.: 18/816,449

(22) Filed: Aug. 27, 2024

(30) Foreign Application Priority Data
Aug. 30, 2023 (JP) 2023-140545
Aug. 9, 2024 (JP) 2024-134042

(51) Int. Cl. C09D 11/38; C09D 11/322

(52) U.S. Cl. CPC C09D 11/38; C09D 11/322

(57) ABSTRACT

An ink jet recording method is provided for recording an image on a recording medium using an ink jet recording apparatus including a liquid ejection head that ejects a liquid composition and a detector that detects the state of the liquid composition. The liquid composition contains a material, such as a coloring material, and a nonionic surfactant. The liquid composition has a conductivity of 10 μS/cm or more. The liquid ejection head has a circulation flow path through which the liquid composition circulates via a liquid chamber. The detector detects the state of the liquid composition using electrical conduction between a pair of electrodes. An ejection element substrate includes a first protective layer blocking contact between a liquid ejection heater and the liquid composition, a second protective layer made of a metal material and a unit configured to apply a voltage to the second protective layer.

### BACKGROUND OF THE INVENTION

### Field of the Invention

The present invention relates to an ink jet recording method, an ink jet recording apparatus, and a liquid composition.

### Description of the Related Art

In recent years, inkjet recording methods have made it possible to record images having high definition and high color developability that are almost equivalent to those achieved by silver halide photography and offset printing, and ink has been required to have higher reliability. As a method for ejecting ink from a recording head, there are a method using mechanical energy and a method using thermal energy. In the case of a thermal method in which ink is ejected from a recording head by the action of thermal energy, the temperature of an ejection heater of the recording head reaches a high temperature. In addition, the heater is subjected to a combination of physical effects such as impacts caused by cavitation due to the generation of a bubble of ink and the shrinkage of the bubble, and chemical effects caused by the ink. To protect the heater from these effects, a protective layer is provided over a heater portion.

When ink is repeatedly ejected, a component in the ink heated to a high temperature turns into a poorly soluble or poorly dispersible substance, which is what is called a “kogation deposit”. Furthermore, a phenomenon occurs in which this “kogation deposit” adheres to a surface of the protective layer. When the kogation deposit adheres to and accumulates on the surface of the protective layer, thermal energy generated by the heater for ejection is not sufficiently transferred to ink to reduce the thermal energy applied to ink, possibly affecting the ejection property. A deterioration in ink ejection property causes image unevenness.

To inhibit the deterioration in ejection property due to the formation of the kogation deposit, various measures have been reported. For example, Japanese Patent Laid-Open No. 2008-105364 discloses a recording head in which a surface layer (upper protective layer) of a protective layer is made of a metal, such as iridium, and an electrochemical reaction is caused using this upper protective layer as an electrode to elute the upper protective layer and thereby remove the kogation deposit. Japanese Patent Laid-Open No. 2009-051146 discloses a recording head in which a protective layer is charged to have the same polarity as an ink component that can become a kogation deposit to perform voltage control to thereby cause electrical repulsion, inhibiting adhesion of a substance that can become a kogation deposit.

A liquid component in ink can evaporate from an ejection port of a recording head to concentrate the ink near the ejection port, increasing its viscosity. Such an increase in the viscosity of ink may reduce the ejection speed of an ink droplet, causing the position where the ink is applied may deviate from the intended position. In particular, when there is a long suspension time before the next ink droplet is ejected or when the ink has a high solid content, the increase in the viscosity of the ink due to evaporation of the liquid component is noticeable. To inhibit such an increase in the viscosity of ink, Japanese Patent Laid-Open No. 2022-065137 discloses a recording head in which a circulation flow path configured to circulate ink is provided near an ejection element. However, in the case of the recording head disclosed in Japanese Patent Laid-Open No. 2022-065137, if the recording head is not correctly connected to the device at the connecting portion of an ink supply path or the like, a large amount of ink may leak out in a short period of time. Japanese Patent Laid-Open No. 2019-177594 discloses an ink jet recording apparatus that can quickly detect the occurrence of ink leakage by measuring the resistance value of a detector including a pair of electrode pins disposed at the connecting portion of the ink supply path.

The inventors have conducted studies to achieve both good continuous ejection stability and good intermittent ejection stability. Specifically, an image was recorded on a recording medium using an ink jet recording apparatus provided with a recording head including the protective layer disclosed in Japanese Patent Laid-Open No. 2009-051146, the circulation flow path disclosed in Japanese Patent Laid-Open No. 2022-065137 and the detector (the pair of electrode pins) disclosed in Japanese Patent Laid-Open No. 2019-177594. The results indicated a new problem of a decrease in the accuracy of detecting liquid leakage over time.

### SUMMARY OF THE INVENTION

Accordingly, the present invention provides an ink jet recording method that achieves excellent continuous ejection stability and excellent intermittent ejection stability and that allows for the high-accuracy detection of the state of a liquid composition, such as an ink. The present invention also provides an ink jet recording apparatus for use in the ink jet recording method.

One disclosed aspect of the present invention is directed to providing an ink jet recording method for recording an image on a recording medium using an ink jet recording apparatus that includes an aqueous liquid composition, a storage portion configured to store the liquid composition, a liquid ejection head configured to eject the liquid composition supplied from the storage portion through a supply system and a detector configured to detect a state of the liquid composition. The liquid composition contains (1) a material selected from the group consisting of a coloring material, a resin and a reactant, the material being soluble or dispersible in the liquid composition by action of an ionic group, and (2) a nonionic surfactant. The liquid composition has a conductivity of 10 μS/cm or more. The liquid ejection head includes an ejection element substrate including an ejection port configured to eject the liquid composition and a liquid chamber disposed in the ejection element substrate and being filled with the liquid composition; and a circulation flow path through which the liquid composition circulates from the storage portion to the liquid ejection head via the liquid chamber. The detector is configured to detect the state of the liquid composition using electrical conduction between a pair of electrodes disposed in the supply system. The ejection element substrate includes a heater configured to eject a liquid, the heater being disposed in a flow path through which the liquid composition flows, and the flow path communicating with the ejection port, a first protective layer disposed at a position corresponding to the heater in the flow path, the first protective layer being configured to block contact between the heater and the liquid composition in the flow path, a second protective layer containing a metal material, the second protective layer being disposed at a position corresponding to the heater in the flow path and configured to come into contact with the liquid composition and a unit configured to apply a voltage to enable a portion of the second protective layer to serve as an electrode charged to a polarity identical to a polarity of the material and to enable a portion of the second protective layer electrically conducting through the liquid composition to serve as an electrode charged to a polarity different from the polarity of the material.

Further features of the present invention will become apparent from the following description of exemplary embodiments with reference to the attached drawings.

### BRIEF DESCRIPTION OF THE DRAWINGS

FIG. 1 is a schematic view illustrating an ink jet recording apparatus according to an embodiment of the present invention.

FIG. 2 is a perspective view illustrating an example of a recording head.

FIG. 3 is a sectional perspective view illustrating an example of an ejection element substrate.

FIG. 4 is a schematic plan view illustrating the vicinity of a liquid ejection heater of an ejection element substrate.

FIG. 5 is a schematic sectional view illustrating a state in which the ejection element substrate is cut perpendicularly along line V-V in FIG. 4.

FIG. 6 illustrates an example of a procedure for voltage control.

FIG. 7 is a schematic view illustrating an example of a supply system for a liquid composition.

FIG. 8 is a schematic view illustrating another example of a heating portion.

FIG. 9 is a schematic view illustrating another example of a fixing portion.

### DESCRIPTION OF THE EMBODIMENTS

The present invention will be described in more detail below with reference to embodiments. In an embodiment of the present invention, when a compound is a salt, the salt in a liquid composition is present in the form of dissociated ions. However, for convenience, it is referred to as “the liquid composition contains the salt”. An aqueous liquid composition (an ink, a reaction liquid or the like) for ink jet recording is also referred to simply as a “liquid composition”, an “ink”, a “reaction liquid” or the like. Unless otherwise specified, physical property values are values at room temperature (25° C.) and normal pressure (1 atom).

As described above, the inventors have conducted studies on an ink jet recording apparatus provided with a recording head including the protective layer disclosed in Japanese Patent Laid-Open No. 2009-051146, the circulation flow path disclosed in Japanese Patent Laid-Open No. 2022-065137 and the detector (the pair of electrode pins) disclosed in Japanese Patent Laid-Open No. 2019-177594 and have found such a new problem that the detection accuracy of states, such as ink leakage and the remaining amount of ink, decreases over time after ink has been ejected over a long period of time. The inventors speculate as to why such a problem occurs when the ink jet recording apparatus having the above configuration is used, as described below.

The detector disclosed in Japanese Patent Laid-Open No. 2019-177594 includes detection pins (pair of electrode pins) configured to detect ink leakage. In this detector, whether there is ink leakage is detected by applying a predetermined voltage to two electrode pins disposed at a connecting portion where the ink supplied from the storage portion flows into the recording head, and measuring the potential difference between the electrode pins. Liquid compositions such as inks typically contain electrolytes composed of cations and anions. In particular, aqueous inks are highly conductive in the presence of an electrolyte because water has a high relative dielectric constant. When a voltage is applied to the electrode pins while ink leaked from the connecting portion is in contact with the two electrode pins, a current flows between the electrode pins via the ink. When the ink is not in contact with the electrode pins (not leaked), there is no path for a current to flow between the electrode pins, and thus no current flows. The results of studies conducted by the inventors revealed that when the conductivity of the ink is 10 μS/cm or more, a current flows reliably between the electrodes to facilitate detection of the state of the ink. However, it was found that even if the conductivity of the ink was 10 μS/cm or more, when the recording head including the protective layer disclosed in Japanese Patent Laid-Open No. 2009-051146 and the circulation flow path disclosed in Japanese Patent Laid-Open No. 2022-065137 was used, the detection accuracy decreased over time. The inventors speculate on the reason for this as described below.

The protective layer disclosed in Japanese Patent Laid-Open No. 2009-051146 is made of a metal material. When ink is ejected, a voltage is applied to the protective layer to allow the protective layer and the electrode disposed opposite the protective layer to have different polarities. That is, when a voltage is applied, the protective layer serves as a cathode or an anode, and the electrode disposed opposite the protective layer serves as an anode or a cathode. When the protective layer serves as a cathode, cations in the ink are attached to the protective layer by electrostatic attraction, and anions are attached to the electrode disposed opposite the protective layer. When the ejection operation is performed, the ink near the liquid ejection heater and the ejection port is ejected from the ejection port to the outside of the recording head. Thus, the cations attached to the protective layer of the heater are ejected to the outside of the recording head together with the ink.

In the circulation flow path disclosed in Japanese Patent Laid-Open No. 2022-065137, ink circulates through the position corresponding to the heater, so that ink having cations is constantly supplied to the vicinity of the heater. For this reason, even if the cations are ejected outside the recording head by the ejection operation, the cations in the ink that is subsequently supplied will be attached to the protective layer of the heater serving as the cathode. The cations are ejected again to the outside of the recording head by the ejection operation. However, the cations are still supplied to the vicinity of the heater through the circulation flow path. The inventors speculate that repetition of such cycles gradually decrease the concentration of the electrolyte in the ink to lead to an ink conductivity of less than 10 μS/cm, thereby decreasing detection accuracy over time.

As a result of further investigation, the inventors have found that the use of a liquid composition, such as an ink, containing a nonionic surfactant makes it possible to maintain the detection accuracy of the state of the liquid composition for a long period of time, even when a recording head having a specific protective layer and circulation flow path is used. The following describes a mechanism by which the use of the liquid composition containing a nonionic surfactant can provide the effect of maintaining the detection accuracy of the state of the liquid composition is maintained for a long period of time.

When a metal material is present together with a surfactant, the surfactant is coordinated with the metal material with its hydrophilic moiety facing the metal material and its hydrophobic moiety facing away from the metal material. The reason why the surfactant is coordinated with the metal material in this manner is presumably due to the transfer of a free electron between the metal material and the hydrophilic moiety of the surfactant. Thus, even when a protective layer made of a metal material is present together with a surfactant, it is believed that the surfactant is coordinated with the protective layer with its hydrophilic moiety facing toward the protective layer and the hydrophobic moiety facing toward the opposite side of the protective layer. No voltage is applied to the protective layer or the electrode disposed opposite the protective layer before ejection; hence, no cations or anions are supplied. It is thus believed that the surfactant is mainly coordinated with the protective layer.

When an anionic surfactant is used, the surfactant coordinated with the protective layer and the electrode disposed opposite the protective layer is released due to electrostatic repulsion upon application of a voltage to the protective layer. In contrast, when a nonionic surfactant is used, since the nonionic surfactant is electrically neutral, the surfactant is not detached even when a voltage is applied to the protective layer, and the surfactant remains in the vicinity of the heater. Thus, the protective layer and the electrode disposed opposite the protective layer remain covered with the nonionic surfactant. This inhibits the attachment of a cation and an anion to the cathode and the anode, and thus these ions are less likely to be ejected to the outside of the recording head. This is believed to maintain the electrolyte concentration in the liquid composition at a constant level, thereby maintaining detection accuracy for a long period of time.

### Ink Jet Recording Method and Ink Jet Recording Apparatus

An ink jet recording method (hereinafter, also referred to simply as a “recording method”) according to an embodiment of the present invention is an ink jet recording method for recording an image on a recording medium using an ink jet recording apparatus. The Ink jet recording apparatus includes an aqueous liquid composition, a storage portion configured to store a liquid composition, a liquid ejection head configured to eject the liquid composition supplied from the storage portion through a supply system and a detector configured to detect a state of the liquid composition. The liquid composition contains (1) a material selected from the group consisting of a coloring material, a resin and a reactant, the material being soluble or dispersible in the liquid composition by action of an ionic group, and (2) a nonionic surfactant. The liquid composition has a conductivity of 10 μS/cm or more. The liquid ejection head includes an ejection element substrate including an ejection port configured to eject the liquid composition and a liquid chamber disposed in the ejection element substrate, the liquid chamber being filled with the liquid composition; and a circulation flow path through which the liquid composition circulates from the storage portion to the liquid ejection head via the liquid chamber. The detector is configured to detect the state of the liquid composition using electrical conduction between a pair of electrodes disposed in the supply system, The ejection element substrate includes a liquid ejection heater, a first protective layer, a second protective layer and a unit configured to apply a voltage (voltage applying unit). The heater is a member disposed in a flow path through which the liquid composition flows, the flow path communicating with the ejection port. The first protective layer is disposed at a position corresponding to the heater in the flow path and serves to block contact between the heater and the liquid composition in the flow path. The second protective layer is made of a metal material, disposed at a position corresponding to the heater in the flow path and configured to come into contact with the liquid composition. The voltage applying unit is a unit configured to apply a voltage to enable a portion of the second protective layer to serve as an electrode charged to a polarity identical to a polarity of the material, which is the material in (1) of the liquid composition, and to enable a portion of the second protective layer electrically conducting through the liquid composition to serve as an electrode charged to a polarity different from the polarity of the material.

An ink jet recording apparatus (hereinafter, also referred to simply as a “recording apparatus”) according to an embodiment of the present invention is an ink jet recording apparatus which includes an aqueous liquid composition, a storage portion configured to store a liquid composition, a liquid ejection head configured to eject the liquid composition supplied from the storage portion through a supply system and a detector configured to detect a state of the liquid composition. The liquid composition contains (1) a material selected from the group consisting of a coloring material, a resin and a reactant, the material being soluble or dispersible in the liquid composition by action of an ionic group, and (2) a nonionic surfactant. The liquid composition has a conductivity of 10 S/cm or more. The liquid ejection head includes an ejection element substrate including an ejection port configured to eject the liquid composition and a liquid chamber disposed in the ejection element substrate, the liquid chamber being filled with the liquid composition; and a circulation flow path through which the liquid composition circulates from the storage portion to the liquid ejection head via the liquid chamber. The detector is configured to detect the state of the liquid composition using electrical conduction between a pair of electrodes disposed in the supply system, The ejection element substrate includes a liquid ejection heater, a first protective layer, a second protective layer and a unit configured to apply a voltage (voltage applying unit). The heater is a member disposed in a flow path through which the liquid composition flows, the flow path communicating with the ejection port. The first protective layer is disposed at a position corresponding to the heater in the flow path and serves to block contact between the heater and the liquid composition in the flow path. The second protective layer is made of a metal material, disposed at a position corresponding to the heater in the flow path and configured to come into contact with the liquid composition. The voltage applying unit is a unit configured to apply a voltage to enable a portion of the second protective layer to serve as an electrode charged to a polarity identical to a polarity of the material, which is the material in (1) of the liquid composition, and to enable a portion of the second protective layer electrically conducting through the liquid composition to serve as an electrode charged to a polarity different from the polarity of the material.

### Ink Jet Recording Apparatus

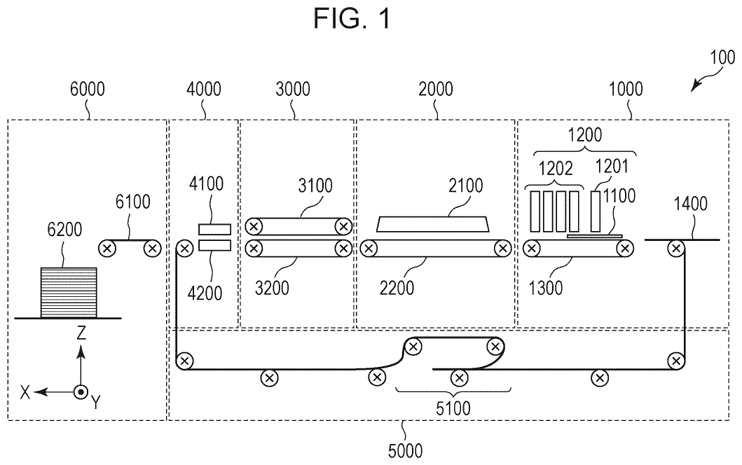

An ink jet recording apparatus will be described in detail below with reference to the drawings. FIG. 1 is a schematic view illustrating an ink jet recording apparatus according to an embodiment of the present invention. The ink jet recording apparatus according to the present embodiment is an ink jet recording apparatus that records an image on a recording medium using an ink and a reaction liquid containing a reactant that reacts with the ink. An X-direction, a Y-direction and a Z-direction represent the width direction (total length direction), depth direction and height direction of the ink jet recording apparatus, respectively. The recording medium is conveyed in the X-direction.

An ink jet recording apparatus 100 of the present embodiment illustrated in FIG. 1 includes a recording portion 1000, a heating portion 2000, a fixing portion 3000, a cooling portion 4000, a reversing portion 5000 and a sheet delivery portion 6000. In the recording portion 1000, various liquids are applied to a recording medium 1100, which has been conveyed from a sheet feeding device 1400 by a conveying member 1300, by a liquid applying device 1200. In the heating portion 2000, the liquids applied to the recording medium 1100 are heated by a heating device 2100 to evaporate volatile components, such as water, in the liquids, thereby performing drying. In the fixing portion 3000, a fixing member 3100 is brought into contact with the region of the recording medium 1100, to which the liquids have been applied, to heat the region, to thereby promote the fixation of an image to the recording medium 1100. The recording medium 1100 is then cooled by the cooling member 4100 of the cooling portion 4000. When an image is to be recorded on the rear surface of the recording medium subsequently to the front surface (recording surface) thereof, first, the recording medium 1100 is reversed by the reversing device 5100 of the reversing portion 5000. After the image is recorded on the rear surface as in the case of the front surface, the recording medium is conveyed by the conveying member 6100 of the sheet delivery portion 6000 and stacked and stored in a recording medium storage portion 6200.

Any medium may be used as the recording medium 1100. For example, such recording media each having ink absorbency (permeability) as described below may each be used as the recording medium 1100: a recording medium free of a coating layer, such as plain paper, uncoated paper or synthetic paper; and a recording medium including a coating layer, such as printing paper, glossy paper or art paper. In addition, a recording medium that does not have permeability like a film or sheet composed of a resin material, such as polyvinyl chloride (PVC) or polyethylene terephthalate (PET), may be used. The basis weight (g/m²) of the recording medium 1100 is preferably 30 g/m² or more to 500 g/m² or less, more preferably 50 g/m² or more to 450 g/m² or less.

### Recording Portion

The recording portion 1000 includes the liquid applying device 1200. The liquid applying device 1200 includes a reaction liquid applying device 1201 and an ink applying device 1202. The reaction liquid applying device 1201 illustrated in FIG. 1 is an example of a unit including an ink jet ejection head. The reaction liquid applying device may also be constituted by utilizing a gravure coater, an offset coater, a die coater, a blade coater or the like. The reaction liquid may be applied by the reaction liquid applying device 1201 before or after the application of the ink as long as the liquid can be brought into contact with the ink on the recording medium 1100. However, to record high-quality images on various recording media having different liquid-absorbing characteristics, the reaction liquid can be applied before the application of the ink. An ink jet ejection head (recording head) is used as the ink applying device 1202. Examples of the ejection system of the ejection head serving as the liquid applying device 1200 include a system including causing film boiling in a liquid with an electrothermal converter to form an air bubble, to thereby eject the liquid; and a system including ejecting the liquid with an electromechanical transducer.

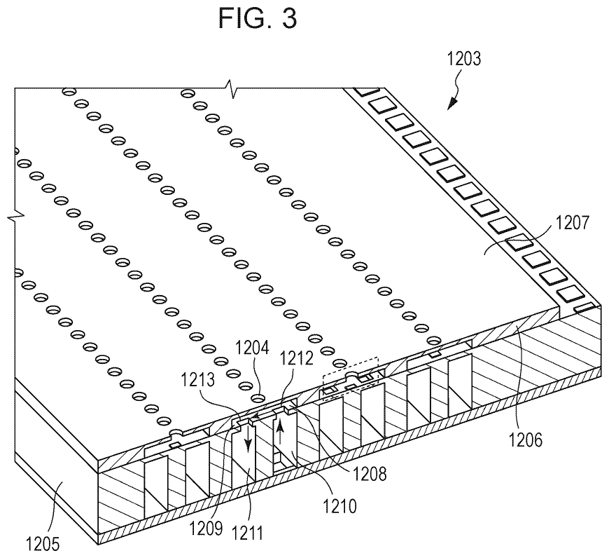

The liquid applying device 1200 is a line head arranged in the Y-direction in an extended manner, and its ejection ports are arrayed in a range covering the image recording region of the recording medium having the maximum usable width. The ejection head has an ejection port surface 1207 (FIG. 3) including an ejection port on its lower side, which is adjacent to the recording medium 1100. The ejection port surface faces the recording medium 1100 with a minute distance of about several millimeters therebetween.

Multiple ink applying devices 1202 may be arranged for applying inks of respective colors to the recording medium 1100. For example, when respective color images are recorded with a yellow ink, a magenta ink, a cyan ink and a black ink, the four ink applying devices 1202 that ejection the above-mentioned four types of inks are arranged side by side in the X-direction. The ink and the reaction liquid are hereinafter sometimes collectively referred to as a “liquid composition” or “liquid”. The term “liquid ejection head” is also referred to as a “recording head”.

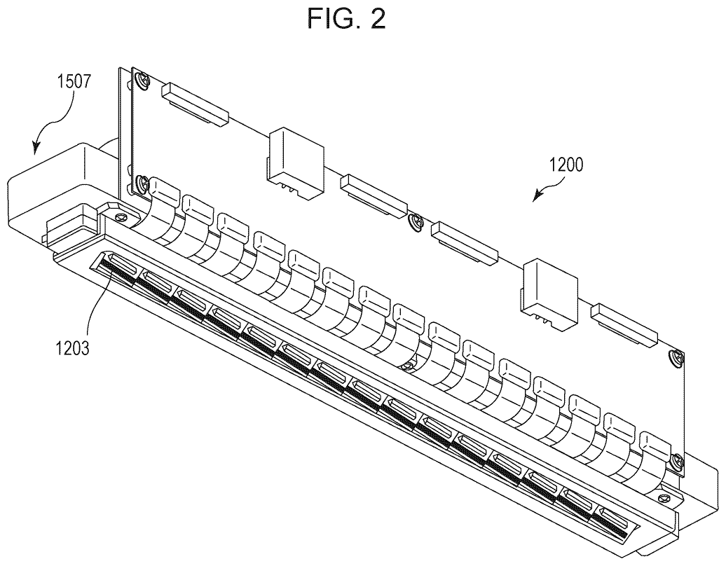

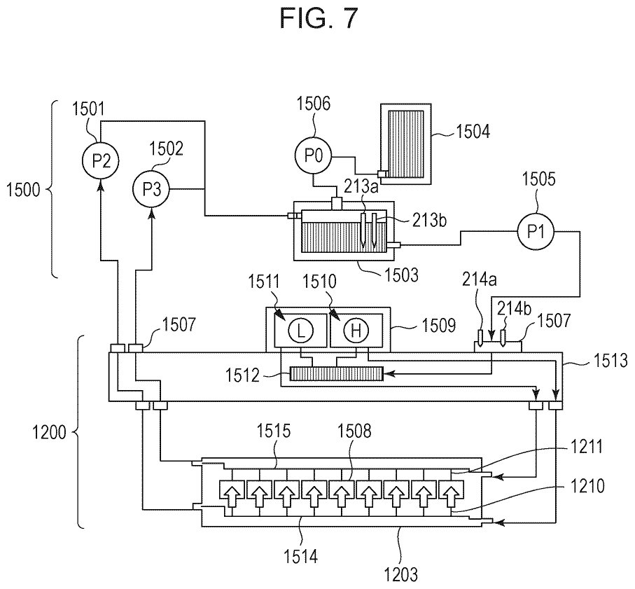

FIG. 2 is a perspective view illustrating an example of the liquid applying device. The liquid applying device 1200 illustrated in FIG. 2 is a line head. The line head includes multiple ejection element substrates 1203 that have ejection port arrays and that are linearly arranged. In each of the ejection element substrates 1203, the multiple ejection port arrays are arranged. An Ink is supplied from an ink storage portion, which is a sub tank described below, to the liquid applying device 1200 via a connection portion (inflow portion) 1507 in FIG. 7.

FIG. 3 is a sectional perspective view illustrating an example of each of the ejection element substrates. The ejection element substrate 1203 illustrated in FIG. 3 includes an ejection port forming member 1206 having an ejection port 1204 opened, and a substrate 1205 having an ejection element (not illustrated) arranged thereon. The lamination of the ejection port forming member 1206 and the substrate 1205 forms a first flow path 1208 and a second flow path 1209 through which a liquid flows. The first flow path 1208 is a region from an inflow port 1212, into which the liquid flows from an inflow path 1210, to a portion between each of the ejection ports 1204 and a corresponding one of the ejection elements (FIG. 7, a liquid chamber 1508). The second flow path 1209 is a region from the portion between the ejection port 1204 and the ejection element (FIG. 7, the liquid chamber 1508) to an outflow port 1213 from which the liquid flows out to an outflow path 1211. For example, if a pressure difference is provided between the inflow port 1212 and the outflow port 1213, such as the inflow port 1212 having a high pressure and the outflow port 1213 having a low pressure, the liquid can be allowed to flow from the higher-pressure side to the lower-pressure side (in the direction of the arrow in FIG. 3). The liquid passed through the inflow path 1210 and the inflow port 1212 enters the first flow path 1208. The liquid passed through the portion between the ejection port 1204 and the ejection element (FIG. 7, the liquid chamber 1508) flows to the outflow path 1211 through the second flow path 1209 and the outflow port 1213.

### Ejection Element Substrate

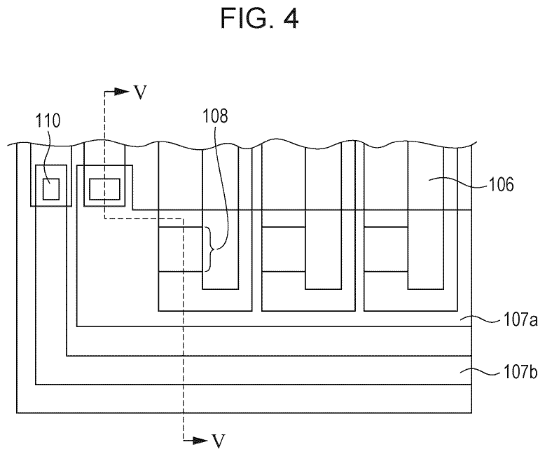

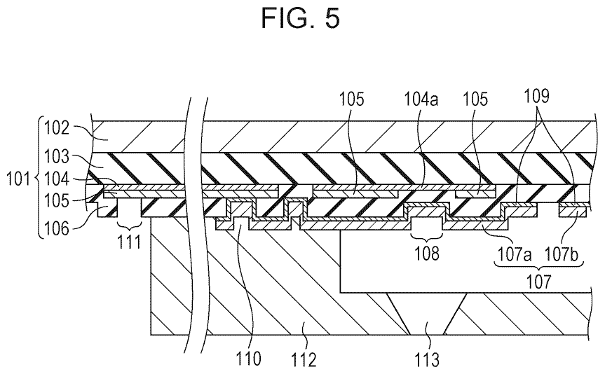

FIG. 4 is a schematic plan view illustrating the vicinity of a liquid ejection heater of an ejection element substrate. FIG. 5 is a schematic sectional view illustrating a state in which the ejection element substrate is cut perpendicularly along line V-V in FIG. 4. The ejection element substrate 101 includes a silicon base 102, a heat storage layer 103, a heating resistor layer 104 and an electrical wiring layer 105. The heat storage layer 103 is formed of a material, such as a thermally oxidized silicon film, a silicon oxide film, or a silicon nitride film. The electrical wiring layer 105 is a wiring formed of a metal material, such as aluminum, aluminum-silicon or aluminum-copper. A heat-generating part 104a serving as a heater (electrothermal transducer) is formed by removing a part of the electrical wiring layer 105 to form a gap and exposing the heating resistor layer 104 in that portion. The electrical wiring layer 105 is connected to a drive element circuit (not illustrated) or an external power supply terminal (not illustrated) and receives power from the outside. In the illustrated example, the electrical wiring layer 105 is disposed adjacent to the heating resistor layer 104. However, an embodiment of the present invention is not limited to this configuration. The electrical wiring layer 105 may be formed as a layer adjacent to the silicon base 102 or the heat storage layer 103. The electrical wiring layer 105 may be partially removed as a gap. The heating resistor layer 104 may be disposed therein.

The first protective layer 106 is made of a material, such as silicon oxide or silicon nitride. The first protective layer 106 is adjacent to the heat-generating part 104a and the electrical wiring layer 105 with the electrical wiring layer 105 partially interposed therebetween. The first protective layer 106 functions as an insulating layer that blocks contact between the heat-generating part 104a and the liquid composition in the flow path.

The second protective layer 107 is the outermost surface layer that comes into contact with the liquid composition in the flow path. A region of the second protective layer 107 that is located on the flow path side of the heat-generating part 104a and that allows the heat generated by the heat-generating part 104a to act on the liquid composition corresponds to a liquid ejection heater 108. The second protective layer 107 protects the heater 108 from chemical and physical impacts (cavitation) that occur as a result of the heat generation of the heat-generating part 104a, and also functions as an electrode. To achieve both of these characteristics, the second protective layer 107 made of a metal material is used.

The second protective layer 107 can be a protective layer that is resistant to a physical action, such as impact due to cavitation, and a chemical action due to the liquid composition. For this reason, a material constituting the protective layer can be a metal material containing at least one metal element selected from the group consisting of iridium, ruthenium and tantalum. Examples of such metal materials include these metal elements; and alloys of these metal elements with other metals. In the case of an alloy, a higher proportion of the above metal element is likely to result in a protective layer that is more resistant to physical and chemical actions. Iridium, ruthenium or tantalum can be used rather than an alloy. Iridium or ruthenium can be used because it is less likely to form a strong oxide film even when heated and can generate a more uniform electric potential, and thus it is possible to further improve continuous ejection stability from the viewpoint of easy removal of an ionic group-containing component attached to the electrode. A surface of the second protective layer is heated to about 300° C. or higher to 600° C. or lower by heat generated by the heater 108. Even in the atmosphere, which is a condition where oxygen is more abundant than in the liquid composition, iridium does not form an oxide film up to 800° C. Therefore, iridium can be used.

The second protective layer 107 can be made of at least one metal element selected from the group consisting of iridium, ruthenium and tantalum, or can be made of a metal material containing at least one of these metal elements. In particular, the metal material constituting the second protective layer 107 can be at least one selected from the group consisting of iridium and ruthenium. However, such metal materials have poor adhesion. For this reason, an adhesive layer 109 is disposed between the first protective layer 106 and the second protective layer 107 to improve the adhesion of the second protective layer 107 to the first protective layer 106. The adhesive layer 109 is formed of an electrically conductive material.

The second protective layer 107 is disposed in a through hole 110 and is electrically connected to the electrical wiring layer 105 with the adhesive layer 109 provided therebetween. The electrical wiring layer 105 extends to the end portion of the ejection element substrate 101. An end portion of the electrical wiring layer 105 serves as an external electrode 111 for electrical connection to the outside. A flow path forming member 112 is bonded to the ejection element substrate 101 having the above-mentioned configuration. The flow path forming member 112 has an ejection port 113 at a position corresponding to the heater 108, and forms a flow path communicating with the ejection port 113 from a supply port (not illustrated) provided through the ejection element substrate 101 via the heater 108.

A method for performing voltage control in the above-described recording head will be described. The second protective layer 107 is composed of two regions, i.e., a region (heater side region 107a) including the heater 108 disposed at a position corresponding to the heat-generating part 104a and a region (counter electrode side region 107b) other than the region, and electrical connection is established to each region. When no liquid is present in the flow path, no electrical connection is established between the heater side region 107a and the counter electrode side region 107b. A liquid, such as a liquid composition, contains an electrolyte as an anionic group-containing component, a cationic group-containing component and an ionic group-containing component, such as a soluble metal ion. Thus, when the flow path is filled with liquid, the heater side region 107a and the counter electrode side region 107b, which is a region electrically connected via the liquid composition, are electrically connected via the liquid.

When voltage control is performed, of the heater side region and the counter electrode side region, a kogation deposit and its causative substance are likely to adhere to the heater side region, which is exposed to heat during ejection. This is because increases in temperature and pressure can destabilize the dispersion of a particle and cause aggregation and precipitation of a low-solubility material. Among the components of the liquid composition, a coloring material, a resin, a reactant and so forth are likely to be substances that cause kogation. Thus, a voltage can be applied to the heater side in such a manner that the heater side is charged to a polarity opposite to the polarity of the components, such as the coloring material, the resin, the reactant and so forth. For example, when a liquid containing an anionic component, such as a coloring material having an anionic group, is used, a voltage is applied in such a manner that the heater side serves as a cathode and the counter electrode side serves as an anode. When a liquid containing a cationic component, such as a polyvalent metal or a cationic resin, is used, a voltage is applied in such a manner that the heater side serves as an anode and the counter electrode side serves as a cathode.

In the case of using a liquid composition containing an anionic component, when energization is performed using the heater side region 107a as a cathode and the counter electrode side region 107b as an anode, a potential difference is generated between these electrodes. A component having an anionic group is electrically repulsive to the heater side region 107a. A soluble metal ion is electrically repulsive to the counter electrode side region 107b. Hence, the distribution state of each component varies in response to the charging state of each electrode. The heater side region 107a is negatively charged. Thus, the component having an anionic group moves away from the vicinity of the heater 108 due to electrical repulsion and is less likely to be attached to the heater, thereby inhibiting a deterioration in ejection property. The counter electrode side region 107b is positively charged. Thus, the component having an anionic group moves toward the counter electrode side region 107b, and some molecules of the component having an anionic group is temporarily attached to the counter electrode side region 107b. However, the component having an anionic group can be removed by the soluble metal ion possibly present in the vicinity of the counter electrode side region 107b. In the case of using a liquid composition containing a cationic component, when energization is performed using the heater side region 107a as an anode and using the counter electrode side region 107b as a cathode, a potential difference is generated between these electrodes. The component having a cationic group can be removed by the same mechanism as that in the case of using the liquid composition containing an anionic component, except that the charged state is reversed. As described above, a combination of the behaviors in the heater side region 107a and the counter electrode side region 107b enables inhibition of the formation of a kogation deposit and the deterioration in ejection property when the voltage control of the recording head is performed.

### Voltage Control Procedure

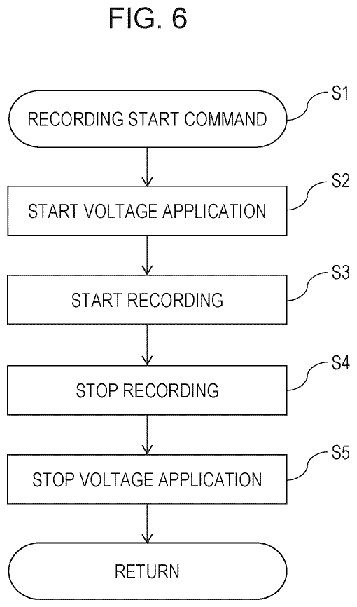

A procedure for performing voltage control will be described. FIG. 6 illustrates an example of a procedure for voltage control. When the recording apparatus receives image data, the image data is converted into data suitable for the recording device (step S1). A potential difference is generated between the heater side region 107a and the counter electrode side region 107b of the second protective layer 107 in a recording head 100 (step S2). At this time, a voltage starts to be applied from the voltage applying unit of the recording apparatus via the ejection element substrate 101 of the recording head 100 using the heater side region 107a of the second protective layer 107 as a cathode and the counter electrode side region 107b as an anode. Thereafter, recording is started by ejecting the liquid (step S3). After the recording is completed (step S4), the application of the voltage between the heater side region 107a and the counter electrode side region 107b of the second protective layer 107 is stopped, and the potential difference generated therebetween is removed (step S5). In the present embodiment, the recording operation by ejecting the liquid includes not only a period during which the recording head ejects the liquid to perform recording, but also a period from the receipt of a recording start command to the completion of the ejection of the liquid.

The voltage control is performed to inhibit the adhesion of a substance that cause kogation to the liquid ejection heater. Thus, voltage control can be continuously performed from a certain time before to a certain time after the timing of the liquid ejection operation based on recording data, preliminary ejection data and so forth. In this case, the period during which the voltage control continues may be appropriately set in consideration of the amount of power consumption, etc. The voltage Eb (V) applied to the second protective layer when the liquid is ejected from the liquid ejection head can be set to less than 2.5 V from the viewpoint of ejection stability during continuous recording. When a voltage of less than 2.5 V is applied for control, water electrolysis is unlikely to occur, and thus the amount of hydrogen ions generated is small. This reduces the amount of the ionic group-containing component precipitated to inhibit the occurrence of kogation. The voltage Eb (V) may be considered as an absolute value. In the examples described below, the voltage Eb (V) is presented as the potential difference between the second protective layer and the counter electrode.

In the case where the heater side region 107a of the second protective layer 107 is used as a cathode and where the counter electrode side region 107b is used as an anode, these electrodes may be controlled by applying a voltage in such a manner that these electrodes have the above-described relationship between the cathode and the anode (FIG. 5). As a control method by voltage application, the following methods (1) to (3) can be used. Among them, the method (1) can be used. In the case where the heater side region 107a is used as an anode and where the counter electrode side region 107b is used as a cathode, a voltage opposite to that described above may be applied.
(1) A method in which the heater side region 107a is grounded and a positive potential is applied to the counter electrode side region 107b.
(2) A method in which a negative potential is applied to the heater side region 107a and the counter electrode side region 107b is grounded.
(3) A method of applying potentials to both the heater side region 107a and the counter electrode side region 107b.

### Supply System

In the recording method according to an embodiment of the present invention, the ink jet recording apparatus including the liquid ejection head is used, the liquid ejection head including the ejection element substrate that includes a liquid chamber disposed therein and being filled with the liquid composition, and the circulation flow path through which the liquid composition circulates from the storage portion to the liquid ejection head via the liquid chamber. FIG. 7 is a schematic view illustrating an example of a supply system for a liquid such as an ink. A supply portion 1500 of the liquid applying device 1200 illustrated in FIG. 7 includes a first circulation pump (high-pressure side) 1501, a first circulation pump (low-pressure side) 1502, a sub tank 1503, and a second circulation pump 1505. The sub tank 1503 connected to a main tank 1504 serving as a liquid storage portion has an air communication port (not illustrated) and hence can discharge air bubbles mixed into a liquid to the outside of a circulation system. The sub tank 1503 is also connected to a replenishment pump 1506. A liquid is consumed in the liquid applying device 1200 by the eject (discharge) of the liquid from an ejection port in, for example, image recording or suction recovery. The replenishment pump 1506 transfers the liquid from the main tank 1504 to the sub tank 1503 in an amount corresponding to the amount consumed.

The first circulation pump (high-pressure side) 1501 and the first circulation pump (low-pressure side) 1502 allows the liquid in the liquid applying device 1200, which has been caused to flow out from a connection portion (inflow portion) 1507, to flow to the sub tank 1503. A positive-displacement pump having a quantitative liquid-delivering ability can be used as each of the first circulation pump (high-pressure side) 1501, the first circulation pump (low-pressure side) 1502 and the second circulation pump 1505. Examples of such positive-displacement pump include a tube pump, a gear pump, a diaphragm pump and a syringe pump. At the time of the driving of each of the ejection element substrates 1203, the liquid can be allowed to flow from a common inflow path 1514 to a common outflow path 1515 by the first circulation pump (high-pressure side) 1501 and the first circulation pump (low-pressure side) 1502.

A negative pressure control unit 1509 includes two pressure adjusting mechanisms in which control pressures different from each other are set. A pressure adjusting mechanism (high-pressure side) 1510 and a pressure adjusting mechanism (low-pressure side) 1511 are connected to the common inflow path 1514 and the common outflow path 1515, respectively, in the ejection element substrate 1203 through a supply unit 1513 having arranged therein a filter 1512 that removes foreign matter from a liquid. The ejection element substrate 1203 includes the common inflow path 1514, the common outflow path 1515, the inflow path 1210 and the outflow path 1211. The inflow path 1210 and the outflow path 1211 communicate with the liquid chamber 1508 serving as the portion between the ejection port 1204 (FIG. 3) and the ejection element (not illustrated). The inflow path 1210 and the outflow path 1211 communicate with the common inflow path 1514 and the common outflow path 1515, respectively. Accordingly, a flow (arrow in FIG. 7) occurs in which part of the liquid passes the inside of the liquid chamber 1508 from the common inflow path 1514 to flow to the common outflow path 1515. The arrows in FIG. 3 indicate the flow of the liquid in the liquid chamber 1508. That is, as illustrated in FIG. 3, the liquid in the first flow path 1208 flows to the second flow path 1209 through a portion between the ejection port 1204 and the ejection element.

The ejection element substrate 1203 includes a flow path A in which a portion of the liquid flows from the common inflow path 1514 via the liquid chamber 1508 to the common outflow path 1515, and a flow path B in which a portion of the liquid flows through the common outflow path 1515 without passing through the liquid chamber 1508. The liquid joined in the common outflow path 1515 flows out from a connection portion (outflow portion) 1507 to the outside of the liquid applying device 1200.

To stably eject the liquid, it is necessary to inhibit changes in physical properties, such as an increase in the viscosity of the liquid composition caused by evaporation of a liquid component from the ejection port and precipitation of a non-volatile component (solid content). An increase in the amount of flow of the liquid is effective in inhibiting the changes in physical properties. Increasing the amount of flow of the liquid can reduce the proportion of the evaporation of the liquid component in the liquid composition. The ejection element substrate 1203 has the flow path B in addition to the flow path A, so that the amount of flow of the liquid can be increased. When a large amount of liquid component evaporates from the ejection port, the physical properties of the liquid are likely to change in the outflow path 1211, and the non-volatile component (solid content) is likely to precipitate. Since the flow path B is provided in which part of the liquid flows through the common outflow path 1515 without passing through the liquid chamber 1508, the liquid that has passed through the liquid chamber 1508 and the liquid that has not passed through the liquid chamber 1508 can be combined together in the common outflow path 1515. This makes it possible to inhibit changes in physical properties, such as an increase in the viscosity of the liquid and the precipitation of the non-volatile component (solid content).

As illustrated in FIG. 7, the pressure adjusting mechanism (high-pressure side) 1510 is connected to the common inflow path 1514, and the pressure adjusting mechanism (low-pressure side) 1511 is connected to the common outflow path 1515. Accordingly, a pressure difference is provided between the inflow path 1210 and the outflow path 1211. Thus, a pressure difference is also provided between the inflow port 1212 (FIG. 3) communicating with the inflow path 1210 and the outflow port 1213 (FIG. 3) communicating with the outflow path 1211. When the liquid is allowed to flow by a pressure difference between the inflow port 1212 and the outflow port 1213, the circulation flow rate (mm/s) of the liquid composition flowing through the circulation flow path can be controlled to 0.1 mm/s or more from the viewpoint of further improving the detection accuracy. It is considered that at a flow rate of the liquid composition of 0.1 mm/s or more, even when a portion of the nonionic surfactant is ejected to the outside of the system, another portion of the nonionic surfactant is rapidly attached to the liquid ejection heater to maintain the ion concentration in the liquid, thus further improving the detection accuracy. When the liquid composition is allowed to flow by the pressure difference between the inflow port 1212 and the outflow port 1213, the circulation flow rate (mm/s) of the liquid composition flowing through the circulation flow path can be controlled to 10.0 mm/s or less.

The negative pressure control unit 1509 has the function of maintaining the pressure in the liquid chamber 1508 at a preset constant pressure even if the amount of the liquid composition flowing in the liquid chamber 1508 varies due to a difference in the amounts of the liquid composition ejected from the ejection ports 1204 (FIG. 3). Two pressure adjusting mechanisms constituting the negative pressure control unit 1509 may each be any mechanism that can control the pressure on the downstream side of the negative pressure control unit 1509 within a certain range centered around a desired set value. An example of such a pressure adjusting mechanism is a mechanism similar to what is called a “pressure reducing regulator”. The use of such a pressure adjusting mechanism can inhibit backflow of the liquid in the liquid chamber 1508. In the case of recording based on recording data, the amount of liquid ejected is different for each ejection port. The use of a pressure adjusting mechanism can generate a uniform flow of the liquid even in the ejection port that is not ejecting the liquid and its flow path, thereby inhibiting changes in physical properties, such as an increase in the viscosity of the liquid and the precipitation of a solid. To maintain the physical properties of the liquid constant and enable stable ejection, the temperature of the liquid flowing through the liquid applying device 1200 is adjusted within a range of 15° C. or higher to 50° C. or lower, preferably 30° C. or higher to 45° C. or lower.

### Detector

In the recording method according to an embodiment of the present invention, an ink jet recording apparatus including a detector for detecting the state of the liquid composition is used. This detector is a system that detects the state of the liquid composition, such as the presence or absence of leakage of the liquid composition in the supply path or the amount of the liquid composition remaining in the storage portion, using electrical conduction between a pair of electrodes arranged in the supply system. The detector is disposed, for example, at any position in the supply system of the liquid composition illustrated in FIG. 7.

A method for detecting leakage of a liquid composition will be described below. As a detector for detecting leakage of the liquid composition, a pair of electrode pins 214a and 214b provided at the connection portion (inflow portion) 1507 and a control board (not illustrated) connected thereto are used. The presence or absence of leakage of the liquid composition is detected by applying a voltage in such a manner that a current flows from the electrode pin 214a to the electrode pin 214b, and measuring the potential difference (resistance value) therebetween. When the liquid composition leaks, a current flows between the pair of electrode pins 214a and 214b via an ionic group-containing component, which is an electrolyte in the liquid composition. At this time, the potential on the electrode pin 214b side is lower than that on the electrode pin 214a side. The presence or absence of the leakage of the liquid composition can be detected by detecting the potential difference by a detector (not illustrated). That is, when a potential difference is detected, it is determined that the liquid composition is leaking in the connection portion (inflow portion) 1507.

A method for detecting the remaining amount of the liquid composition will be described. As a detector for detecting the remaining amount of the liquid composition, a pair of electrode pins 213a and 213b provided in the sub tank 1503 and a control board (not illustrated) connected thereto are used. When the liquid composition is consumed, the remaining amount is detected by applying a voltage in such a manner that a current flows from the electrode pin 213a to the electrode pin 213b, and measuring the potential difference (resistance value) therebetween. When the remaining amount of the liquid composition is less than a certain value, no electrical conduction is established via the ionic group-containing component, which is an electrolyte in the liquid composition, and thus no potential difference is detected. In contrast, when the remaining amount of the liquid composition is greater than or equal to a certain value, a current flows between the pair of electrode pins 213a and 213b via the ionic group-containing component, which is the electrolyte in the liquid composition. At this time, the potential on the electrode pin 213b side is lower than that on the electrode pin 213a side. It is thus determined that the remaining amount of the liquid composition is more than or equal to a certain value by detecting the potential difference by a detector (not illustrated).

Increasing the voltage applied to the electrode pins facilitates detection of the potential difference to increase the detection accuracy. Thus, the voltage Ea (V) applied to the electrodes when the detector detects the state of the liquid composition can be 2.5 V or more. Ea (V) is preferably 2.5 V or more to 5.0 V or less, more preferably 2.5 V or more to 4.0 V or less. The voltage applied to the electrodes (electrode pins 214a and 214b) when the detector detects the state of the liquid composition is defined as “Ea (V)”, and the voltage applied to the second protective layer 107 (FIG. 5) when the liquid ejection head ejects the liquid composition is defined as “Eb (V)”. In this case, the relationship Eb<2.5≤Ea can be satisfied. A voltage Ea (V) of less than 2.5 V may result in a slight decrease in detection accuracy. A voltage Eb (V) of 2.5 V or more may result in a slight decrease in continuous ejection stability. That is, satisfying the relationship Eb<2.5≤Ea can further improve the detection accuracy and the continuous ejection stability. The absolute value of Eb (V) can be 0.0 V or more to less than 2.5 V.

### Conveyance System

As illustrated in FIG. 1, the recording portion 1000 includes the liquid applying device 1200 and the conveying member 1300 that conveys the recording medium 1100. The reaction liquid and the ink are applied to the desired positions of the recording medium 1100, which is conveyed by the conveying member 1300, by the liquid applying device 1200. The respective components of the liquid applying device receive the image signal of recording data to apply the required reaction liquid and ink to the respective positions. Although the conveying member 1300 in the form of a conveying belt is illustrated in FIG. 1, for example, a spur or a conveying cylinder may be used as long as the spur or the conveying cylinder has a function of conveying the recording medium 1100. To improve conveyance accuracy, a member that can fix the recording medium 1100 can be used as the conveying member 1300. Specific examples thereof include a technique including arranging holes in the conveying member 1300 and suctioning the recording medium 1100 from its rear surface side to fix the recording medium; and a technique including forming the conveying member 1300 from an appropriate material and electrostatically adsorbing the recording medium 1100 to fix the recording medium.

### Heating Portion

As illustrated in FIG. 1, the heating portion 2000 includes a heating device 2100 and a conveying member 2200. The recording medium 1100 to which the reaction liquid and the ink have been applied and on which an image has been recorded is heated by the heating device 2100 while being conveyed by the conveying member 2200, thereby evaporating the liquid component of the image to dry the image. The recording method can further include, between an ink applying step and a fixing step, a drying step of subjecting the recording medium to which the ink has been applied to non-contact heating to dry the ink. When the drying step is included, the deformation (cockling or curl) of the recording medium 1100 can be effectively inhibited.

The heating device 2100 may have any configuration as long as the device can heat the recording medium 1100. Various devices used in the art, such as a warm-air dryer and a heater, may each be used. Of these, a non-contact heater, such as a heating wire or an infrared heater, can be used in terms of safety and energy efficiency. To jet a heated gas to the recording medium 1100, the use of a mechanism for blowing a warm gas with a built-in fan easily improves the drying efficiency.

With regard to a method for the heating, the recording medium 1100 may be heated from the side of a surface (recording surface (front surface)) to which the reaction liquid and the ink have been applied, may be heated from its rear surface side or may be heated from both the surfaces. The conveying member 2200 may have a heating function. Although the conveying member 2200 using a conveying belt is illustrated in FIG. 1, for example, a spur or a conveying cylinder may be used as long as the spur or the conveying cylinder has the function of conveying the recording medium 1100. From the viewpoint of inhibiting the deformation of the recording medium 1100 by the heating, a configuration can be used in which the recording medium 1100 is conveyed while brought into close contact with the conveying member 2200 by blowing air from the heating portion 2000, or a mechanism can be arranged by which the recording medium is fixed to the conveying member 2200. Specific examples thereof include a technique including arranging holes in the conveying member 2200 and suctioning the recording medium 1100 from its rear surface side to fix the recording medium; and a technique including forming the conveying member 2200 from an appropriate material and electrostatically adsorbing the recording medium 1100 to fix the recording medium.

A heating temperature can be set in such a manner that a liquid component is quickly evaporated and that the recording medium 1100 is not overdried from the viewpoint of inhibiting the deformation of the recording medium 1100. In view of the conveying speed and the environmental temperature, the temperature of a dryer can be set in such a manner that the recording medium has a desired temperature. Specifically, the temperature of the dryer, such as a warm-air dryer, is preferably set to 40° C. or higher to 100° C. or lower, more preferably 60° C. or higher to 80° C. or lower. When a heated gas is blown to heat the recording medium 1100, a gas velocity can be set to 1 m/s or more to 100 m/s or less. The temperature of wind, such as warm air, can be measured using a K-type thermocouple thermometer. A specific example of a measuring machine is a machine available under the trade name “AD-5605H” (manufactured by A&D Company, Limited).

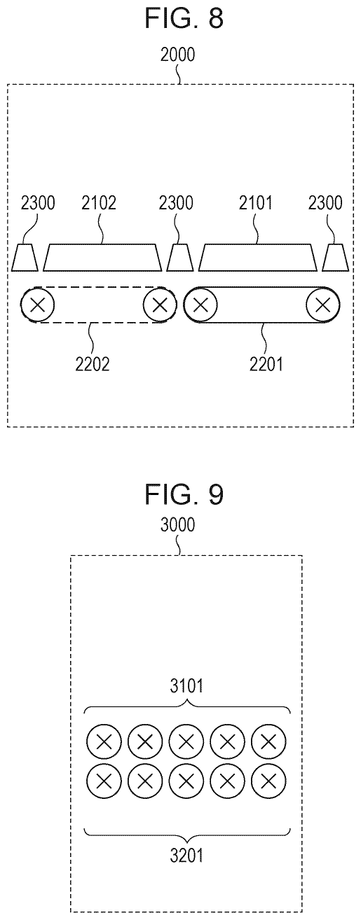

FIG. 8 is a schematic view illustrating another example of the heating portion. Here, the differences from the heating portion illustrated in FIG. 1 and described above will be described. The heating portion 2000 illustrated in FIG. 8 includes a first heating device 2101, a second heating device 2102, a first conveying member 2201 and a second conveying member 2202, the first conveying member 2201 facing the first heating device 2101, and the second conveying member 2202 facing the second heating device 2102.

The first conveying member 2201 is not provided with a mechanism for fixing the recording medium 1100 by suction. The recording medium 1100 is conveyed while pressed against the first conveying member 2201 by warm air from the first heating device 2101. Thus, the recording medium 1100 can be delivered from the conveying member 1300 (FIG. 1) to the first conveying member 2201 and from the first conveying member 2201 to the second conveying member 2202 with high accuracy. In addition, a conveyance shift due to a slight difference in conveying speed between the conveying member 1300 (FIG. 1) and the first conveying member 2201 can be reduced. Meanwhile, a conveying belt having holes that can pass a gas therethrough is used for the second conveying member 2202, and the recording medium 1100 is conveyed while fixed to the second conveying member 2202 with a suction mechanism (not illustrated).

Air knives 2300 are arranged between the conveying member 1300 (FIG. 1) and the first conveying member 2201, between the first conveying member 2201 and the second conveying member 2202 and between the second conveying member 2202 and a conveying member 3200 (FIG. 1). The lifting of the leading end portion of the recording medium 1100 conveyed is pressed down with a wind pressure from the air knives 2300. Thus, the collision of the leading end portion of the recording medium 1100 with the first heating device 2101, the second heating device 2102 and the fixing member 3100 (FIG. 1) can be avoided to inhibit the occurrence of a conveyance failure.

The first heating device 2101 and the second heating device 2102 may each have the same configuration as that of the above-mentioned heating device 2100. The first heating device 2101 and the second heating device 2102 may have the same or different temperatures. In the case of heating by blowing a heated gas, the gas velocity may be the same or different. Heating may be performed from the first conveying member 2201 and the second conveying member 2202, as needed.

### Fixing Portion

As illustrated in FIG. 1, the fixing portion 3000 is a contact-type heat and pressure-applying mechanism including the fixing member 3100 serving as a fixing belt, such as an endless belt, and the conveying member 3200. In the fixing portion 3000, the recording medium 1100 is conveyed by the conveying member 3200. The fixing member 3100 is brought into contact with the recording medium 1100 while pressure is applied to the recording medium 1100, to heat the liquids, such as the reaction liquid and the ink, applied to the recording medium 1100. Thereby, an image can be fixed to the recording medium 1100. After the liquid components of the reaction liquid and the ink permeate in the recording medium 1100 on which the image has been recorded, and evaporate as they pass through the heating portion 2000, the image are fixed in the fixing portion 3000, thereby resulting in the completion of the image. Heat and pressure are applied to the recording medium 1100 while the recording medium 1100 is interposed between the fixing member 3100 and the conveying member 3200, so that the image on the recording medium 1100 comes into close contact with the fixing member 3100, thereby fixing the image to the recording medium 1100. When a liquid, such as ink containing a resin particle and a coloring material, is used, the resin particle is softened and forms a film mainly by heating in the fixing portion 3000, and the coloring material can be bound to the recording medium 1100.

An example of a method for heating the fixing member 3100 is a method in which heating is performed by a heat source, such as a halogen heater, disposed in a roller that drives the fixing member 3100 serving as a fixing belt. A further example thereof is a method in which heating is performed by a heat source, such as an infrared heater, at a location separate from the fixing member 3100. These methods may be combined with each other. The conveying member 3200 may be heated, as needed. In consideration of the conveying speed and the environmental temperature, the temperature of the fixing member 3100 can be set in such a manner that the surface of the recording medium has a desired temperature. Specifically, the temperature of the fixing member 3100 is preferably 50° C. or higher to 120° C. or lower, more preferably 60° C. or higher to 110° C. or lower. The temperature of the contact-type heat and pressure-applying mechanism (fixing member 3100) and the surface temperature of the recording medium immediately after passing through the contact-type heat and pressure-applying mechanism can both be measured using a radiation thermometer. The radiation thermometer is only required to be disposed near an end portion (terminal) of the contact-type heat and pressure-applying mechanism. A specific example of the radiation thermometer is a thermometer available under the trade name “Radiation Thermometer IT-545S” (manufactured by Horiba, Ltd.).

When a liquid, such as a reaction liquid or an ink, contains a resin particle, a temperature of the fixing member 3100 higher than or equal to the glass transition temperature of the resin particle in the liquid can result in softening of the resin particle to easily form a film, thereby improving the abrasion resistance of the image. When a liquid, such as a reaction liquid or an ink, contains a wax particle, the temperature of the fixing member 3100 can be lower than the melting point of the wax constituting the wax particle. This enables the wax that is inhibited from melting easily to remain on the surface of the image more easily, thereby improving the abrasion resistance of the image.

A nip pressure between the fixing member 3100 and the conveying member 3200, that is, a pressure applied to the recording medium when the medium passes through the contact-type heat and pressure-applying mechanism is preferably 10 Pa or more to 1,000 Pa or less, more preferably 10 Pa or more to 500 Pa or less. The pressure is particularly preferably 10 Pa or more to 100 Pa or less. The time period (nip time) required for the recording medium to pass through the contact-type heat and pressure-applying mechanism is preferably 0.25 seconds or more to 5.0 seconds or less, more preferably 0.5 seconds or more to 4.0 seconds or less, and particularly preferably 1.0 second or more to 3.0 seconds or less.

FIG. 9 is a schematic view illustrating another example of the fixing portion. Here, the differences from the fixing portion illustrated in FIG. 1 and described above will be described. The fixing portion 3000 illustrated in FIG. 9 is a contact-type heat and pressure-applying mechanism including a plurality of fixing rollers 3101 and a plurality of conveying members 3201 facing these fixing rollers 3101. The recording medium 1100 to which a liquid such as ink has been applied passes between the fixing rollers 3101 and the conveying members 3201, thereby fixing an image to the recording medium. It is possible to adjust the extent to which the image is fixed to the recording medium by controlling the number of fixing rollers 3101, the number of conveying members 3201, the nip time of the recording medium, the temperature, the pressure and so forth.

### Cooling Portion

The cooling portion 4000 includes the cooling member 4100 and a conveying member 4200 (FIG. 1). The cooling portion 4000 cools the recording medium 1100 that has passed through the heating portion 2000 and the fixing portion 3000 to have a high temperature. The cooling member 4100 may have any configuration as long as it can cool the recording medium 1100, and methods such as air cooling and water cooling can be used. In particular, blowing an unheated gas can be performed from the viewpoint of safety and energy efficiency. To jet a gas to the recording medium 1100, the use of a mechanism for blowing a gas with a built-in fan easily improves the cooling efficiency. In view of the conveying speed and the environmental temperature, the temperature of a cooling unit can be set in such a manner that the recording medium has a desired temperature. Specifically, the temperature of the cooling unit, such as an air blower, is preferably 20° C. or higher to 60° C. or lower, more preferably 25° C. or higher to 50° C. or lower. When cooling is performed by blowing a gas, the gas velocity can be 1 m/s or more to 100 m/s or less. The use of the conditions can inhibit the deformation of the recording medium 1100 to be stacked in the sheet delivery portion 6000 described below and the image sticking (blocking).

### Reversing Portion

When double-sided recording is performed, the recording medium 1100 is reversed by the use of the reversing portion 5000 (FIG. 1). The recording medium 1100 having an image recorded on its recording surface (front surface) passes through the cooling portion 4000, is then conveyed to a branch line, and reversed by the reversing device 5100. The recording medium 1100 that has been reversed is conveyed to the sheet feeding device 1400 of the recording portion 1000 in such a manner that the liquids can be applied to its rear surface, which is a surface opposite to the recording surface (front surface).

### Sheet Delivery Portion

The recording medium 1100 after the image recording is stored in the sheet delivery portion 6000 (FIG. 1). The recording medium 1100 is subjected to single-sided recording or double-sided recording, and then passes through the cooling portion 4000, is conveyed by the conveying member 6100 and finally stored in a stacked state in the recording medium storage portion 6200. Two or more recording medium storage portions 6200 may be arranged for, for example, separately storing different recorded articles.

### Liquid Composition

The aqueous liquid composition for use in the recording method according to an embodiment of the present invention is a composition for ink jet recording, the composition containing (1) a material selected from the group consisting of a coloring material, a resin and a reactant, the material being soluble or dispersible in the liquid composition by action of an ionic group, and (2) a nonionic surfactant. Specific examples of the liquid composition include an “ink” containing a coloring material and a resin and a “reaction liquid” containing a reactant that reacts with the ink. The ink may be clear ink that contains substantially no coloring material. The reaction liquid and the clear ink are liquid compositions that contain substantially no coloring material. Even if only the reaction liquid or the clear ink is used without using an ink containing a coloring material, an image can be recorded in accordance with the type of recording medium. Of course, an image can also be recorded using a combination of a liquid composition (reaction liquid or clear ink) containing substantially no coloring material and a liquid composition (ink) containing a coloring material.

### Conductivity

The liquid composition has a conductivity of 10 μS/cm or more. The conductivity of the liquid composition can be 100 μS/cm or more because even a smaller amount of leakage of the liquid composition can be detected. The upper limit of conductivity of the liquid composition is not limited to a particular value. For example, the upper limit can be 3,000 μS/cm or less.

The conductivity of the liquid composition can be measured with a general-purpose conductivity meter. The conductivity of the liquid composition can be controlled, for example, by adjusting the type and amount of ionic component contained in the liquid composition.

### Surfactant

The liquid composition contains a nonionic surfactant. The nonionic surfactant can be a hydrocarbon-based nonionic surfactant. Examples of the hydrocarbon-based nonionic surfactant include polyoxyethylene alkyl ethers, ethylene oxide adducts of acetylene glycol, and polyethylene glycol-polypropylene glycol block copolymers.

The liquid composition can further contain various types of surfactants. Examples of the surfactant include hydrocarbon-based surfactants, fluorine-based surfactants, and silicone-based surfactants. These surfactants may be any of nonionic surfactants, anionic surfactants, cationic surfactants, and amphoteric surfactants.

The amount (% by mass) of the surfactant, including the nonionic surfactant, contained in the liquid composition is preferably 0.1% by mass or more to 5.0% by mass or less, more preferably 0.2% by mass or more to 1.5% by mass or less, based on the total mass of the liquid composition.

### Reaction Liquid

The recording method according to an embodiment of the present invention can include the reaction liquid applying step of applying the aqueous reaction liquid containing the reactant that reacts with the aqueous ink to the recording medium. The reaction liquid containing a material soluble or dispersible in the liquid composition by the action of an ionic group can be used as the liquid composition described above. Components and so forth used in the reaction liquid will be described in detail below.

### Reactant

The reaction liquid reacts with the ink when the reaction liquid comes into contact with the ink, to allow a component, such as a component having an anionic group, e.g., a resin, a surfactant or a self-dispersible pigment, in the ink to aggregate, and contains a reactant. The presence of the reactant destabilizes the state of the component having an anionic group in the ink when the ink comes into contact with the reactant on the recording medium, and can promote aggregation of the component in the ink. Examples of the reactant include cationic components, such as polyvalent metal ions and cationic resins, and organic acids. These reactants may be used alone or in combination of two or more.

Examples of polyvalent metal ions constituting polyvalent metal salts include divalent metal ions, such as Ca²⁺, Cu²⁺, Ni²⁺, Mg²⁺, Sr²⁺, Ba²⁺ and Zn²⁺; and trivalent metal ions, such as Fe³⁺, Cr³⁺, Y³⁺ and Al³⁺. To incorporate a polyvalent metal ion into the reaction liquid, a water-soluble polyvalent metal salt, which may be a hydrate, formed by combining a polyvalent metal ion with an anion can be used. Examples of the anion include inorganic anions, such as Cl⁻, Br⁻, I⁻, ClO⁻, ClO₂⁻, ClO₃⁻, ClO₄⁻, NO₂⁻, NO₃⁻, SO₄²⁻, Co₃²⁻, HCO₃⁻, PO₄³⁻, HPO₄²⁻ and H₂PO₄⁻; and organic anions, such as HCOO⁻, (COO⁻)₂, COOH(COO⁻), CH₃COO⁻, CH₃CH(OH)COO⁻, C₂H₄(COO⁻)₂, C₆H₅COO⁻, C₆H₄(COO⁻)₂ and CH₃SO₃⁻. When a polyvalent metal ion is used as the reactant, the content (% by mass) in terms of a polyvalent metal salt in the reaction liquid can be 1.0% by mass or more to 20.0% by mass or less based on the total mass of the reaction liquid. In the present specification, when the polyvalent metal salt is a hydrate, the term “polyvalent metal salt content (% by mass)” in the reaction liquid refers to the “anhydrous polyvalent metal salt content (% by mass)” excluding water in the hydrate.

The reaction liquid containing an organic acid has a buffering capacity in the acidic region (a pH of less than 7.0, such as a pH of 2.0 or more to 5.0 or less) and thus efficiently converts the anionic group of the component present in the ink into an acid form, thereby allowing them to aggregate. Examples of the organic acid include monocarboxylic acids and salts thereof, such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumalic acid; dicarboxylic acids and salts and hydrogen salts thereof, such as oxalic acid, malonic acid, succinic acid, glutaric acid, adipic acid, maleic acid, fumaric acid, itaconic acid, sebacic acid, phthalic acid, malic acid and tartaric acid; tricarboxylic acids and salts and hydrogen salts thereof, such as citric acid and trimellitic acid; and tetracarboxylic acids and salts and hydrogen salts thereof, such as pyromellitic acid. When an organic acid is used as the reactant, the organic acid content (% by mass) of the reaction liquid can be 1.0% by mass or more to 50.0% by mass or less based on the total mass of the reaction liquid.

Examples of cationic resins include resins having a primary, secondary or tertiary amine structure, and resins having a quaternary ammonium salt structure. Specific examples thereof include resins having structures of, for example, vinylamine, allylamine, vinylimidazole, vinylpyridine, dimethylaminoethyl methacrylate, ethyleneimine, guanidine, diallyldimethylammonium chloride and alkylamine-epichlorohydrin condensates. To improve the solubility in the reaction liquid, a cationic resin may be used in combination with an acidic compound, or the cationic resin may be subjected to quaternization treatment. When a cationic resin is used as the reactant, the cationic resin content (% by mass) of the reaction liquid can be 0.1% by mass or more to 10.0% by mass or less based on the total mass of the reaction liquid.

The reactant can be a polyvalent metal ion. The use of a reaction liquid containing a polyvalent metal ion as a reactant can further improve the continuous ejection stability. Compared with organic acids and cationic resins, the anions of water-soluble polyvalent metal salts, which can generate polyvalent metal ions by ionic dissociation, are less likely to corrode metals. For this reason, the use of a reaction liquid containing polyvalent metal ions as a reactant is considered to result in less electrode wear and improved continuous ejection stability even during long-term continuous use.

### Aqueous Medium

The reaction liquid is an aqueous reaction liquid containing at least water as an aqueous medium. Examples of the aqueous medium for use in the reaction liquid include the same ones as the aqueous medium which can be contained in the ink, which will be described below. The aqueous medium for use in the reaction liquid may contain a water-soluble organic solvent, which will be described below and which can be contained in the ink. The water-soluble organic solvent content (% by mass) of the reaction liquid can be 1.0% by mass or more to 45.0% by mass or less based on the total mass of the reaction liquid. The water-soluble organic solvent can contain a specific water-soluble hydrocarbon compound described below. The water-soluble hydrocarbon compound content (% by mass) of the reaction liquid can be 1.0% by mass or more to 20.0% by mass or less based on the total mass of the reaction liquid. The water content (% by mass) of the reaction liquid can be 50.0% by mass or more to 95.0% by mass or less based on the total mass of the reaction liquid.

### Other Components

The reaction liquid may contain various other components as needed. Examples of the other components include the same other components that can be contained in the ink, which will be described below.

### Physical Properties of Reaction Liquid

The reaction liquid is an aqueous reaction liquid for use in the ink jet method. Thus, from the viewpoint of reliability, the physical property values of the reaction liquid can be appropriately controlled. Specifically, the surface tension of the reaction liquid at 25° C. can be 20 mN/m or more to 60 mN/m or less. The viscosity of the reaction liquid at 25° C. can be 1.0 mPa·s or more to 10.0 mPa·s or less. The pH of the reaction liquid at 25° C. is preferably 5.0 or more to 9.5 or less, more preferably 6.0 or more to 9.0 or less.

### Ink

The recording method according to an embodiment of the present invention includes, for example, an ink applying step of applying an aqueous ink for ink jet recording to a recording medium to record an image. An ink containing a material soluble or dispersible in the liquid composition by the action of an ionic group can be used as the liquid composition described above. The ink does not need to be cured by active energy rays, such as ultraviolet rays or electron beams, and therefore does not need to contain a monomer that polymerizes when irradiated with active energy rays. Components and so forth used for the ink will be described in detail below.

### Coloring Material

The ink can contain a coloring material. As the coloring material, a pigment or a dye can be used. The coloring material content (% by mass) of the ink is preferably 0.5% by mass or more to 15.0% by mass or less, more preferably 1.0% by mass or more to 10.0% by mass or less, based on the total mass of the ink.

Specific examples of the pigment include inorganic pigments, such as carbon black and titanium oxide; and organic pigments, such as azo, phthalocyanine, quinacridone, isoindolinone, imidazolone, diketopyrrolopyrrole and dioxazine. The pigments may be used alone or in combination of two or more.

With regard to a method for dispersing the pigment, a resin-dispersed pigment using a resin as a dispersant, or a self-dispersible pigment in which a hydrophilic group is bonded to the surface of a pigment particle can be used. A resin-bonded pigment in which a resin-containing organic group is chemically bonded to the surface of a pigment particle, and a microencapsulated pigment in which the surface of a pigment particle is coated with a resin or the like can also be used. It is also possible to use a combination of these pigments having different dispersion methods. In particular, a resin-dispersed pigment in which a resin serving as a dispersant is physically adsorbed onto the surface of a pigment particle can be used, rather than a resin-bonded pigment or a microencapsulated pigment.

As a resin dispersant for dispersing a pigment in an aqueous medium, a dispersant that can disperse a pigment in an aqueous medium by the action of an anionic group can be used. As a resin dispersant, a resin having an anionic group can be used, and a resin as described below, particularly a water-soluble resin, can be used. The pigment content (% by mass) of the ink can be 0.3 to 10.0 times the resin dispersant content (% by mass) in terms of mass ratio.

As the self-dispersible pigment, it is possible to use a pigment in which an anionic group, such as a carboxylic acid group, a sulfonic acid group or a phosphonic acid group, is bonded to the surface of a pigment particle directly or with another atomic group (—R—) interposed therebetween. The anionic group may be in an acid form or a salt form. When the anionic group is in a salt form, the anionic group may be in a partially dissociated state or a completely dissociated state. When the anionic group is in a salt form, examples of a cation serving as a counter ion include an alkali metal cation, ammonium and organic ammonium. Specific examples of the other atomic group (—R—) include linear or branched alkylene groups having 1 to 12 carbon atoms; arylene groups, such as a phenylene group and a naphthylene group; carbonyl groups; imino groups; amide groups; sulfonyl groups; ester groups; and ether groups. It may also be a combination of these groups.

A dye having an anionic group can be used. Specific examples of the dye include azo, triphenylmethane, (aza)phthalocyanine, xanthene and anthrapyridone dyes. These dyes may be used alone or in combination of two or more.

The coloring material can be at least one selected from the group consisting of a self-dispersible pigment having an anionic group, and a resin-dispersed pigment dispersed by a resin dispersant having an anionic group. The use of the ink containing such a self-dispersible pigment or a resin-dispersed pigment as a coloring material can further improve the continuous ejection stability. Unlike dyes, which are coloring materials that are present in a dissolved state, pigments, which are coloring materials that are not dissolved in ink, have a low probability of contact with the heater of the recording head and have excellent wettability. For this reason, the use of an ink containing such a self-dispersible pigment or resin-dispersed pigment as a coloring material is considered to result in less electrode wear and improved continuous ejection stability even during long-term continuous use.

### Resin

The ink can contain a resin. The use of the ink containing the resin can record an image having improved abrasion resistance. The resin can be added to the ink in order to (i) stabilize the dispersion state of the pigment, that is, the resin can be added as a resin dispersant or its aid. The resin can also be added to the ink in order to (ii) improve various characteristics of the image to be recorded.

The resin content (% by mass) of the ink is preferably 0.1% by mass or more to 20.0% by mass or less, more preferably 0.5% by mass or more to 15.0% by mass or less, based on the total mass of the ink. Examples of the form of the resin include a block copolymer, a random copolymer, a graft copolymer and a combination thereof. The resin may be a water-soluble resin soluble in an aqueous medium, or may be a resin particle dispersible in an aqueous medium. These resins may be used alone or in combination of two or more.

The resin can be at least one selected from the group consisting of a resin particle containing a resin having an anionic group, and a resin particle dispersed by a dispersant. The use of the ink containing the resin particle can further improve intermittent ejection stability. The resin particle present in the ink in a particle state is unlikely to form a gel-like substance because of its small contact area with the water-soluble organic solvent in the ink. Thus, the use of the ink containing such a resin particle is considered to improve the intermittent ejection stability because the ink is less likely to increase its viscosity even if the liquid component evaporates.

### Resin Composition

Examples of the resin include an acrylic resin, a urethane-based resin and an olefin-based resin. Among them, an acrylic resin and a urethane-based resin can be used, and an acrylic resin composed of units derived from (meth)acrylic acid or (meth)acrylate can be used.

An acrylic resin having a hydrophilic unit and a hydrophobic unit as constituent units can be used as the acrylic resin. Among them, a resin having a hydrophilic unit derived from (meth)acrylic acid and a hydrophobic unit derived from at least one of a monomer having an aromatic ring and a (meth)acrylic acid ester monomer can be used. In particular, a resin having a hydrophilic unit derived from (meth)acrylic acid and a hydrophobic unit derived from at least one monomer selected from styrene and α-methylstyrene can be used. These resins easily interact with pigments, and thus can be used as resin dispersants for dispersing pigments.

The hydrophilic unit is a unit having a hydrophilic group such as an anionic group. The hydrophilic unit can be formed, for example, by polymerizing a hydrophilic monomer having a hydrophilic group. Specific examples of the hydrophilic monomer having a hydrophilic group include acidic monomers having a carboxylic acid group, such as (meth)acrylic acid, itaconic acid, maleic acid and fumaric acid; and anionic monomers, such as anhydrides and salts of these acidic monomers. Examples of a cation constituting the salt of the acidic monomer include a lithium ion, a sodium ion, a potassium ion, an ammonium ion and organic ammonium ion. The hydrophobic unit is a unit having no hydrophilic group, such as an anionic group. The hydrophobic unit can be formed, for example, by polymerizing a hydrophobic monomer having no hydrophilic group, such as an anionic group. Specific examples of the hydrophobic monomer include monomers having an aromatic ring, such as styrene, α-methylstyrene and benzyl (meth)acrylate; and (meth)acrylic acid ester monomers, such as methyl (meth)acrylate, butyl (meth)acrylate and 2-ethylhexyl (meth)acrylate.

The urethane-based resin can be prepared, for example, by reacting a polyisocyanate with a polyol. The urethane-based resin may also be one that has been reacted with a chain extender. Examples of the olefin-based resin include polyethylene and polypropylene.

### Resin Properties

In the present specification, the expression “a resin is water-soluble” indicates that when the resin is neutralized with an alkali equivalent to the acid value, the resin is present in an aqueous medium in a state in which the resin is not in the form of a particle having a particle size that can be measured by a dynamic light scattering method. Whether a resin is water-soluble can be determined according to a method described below. First, a liquid (resin solid content: 10% by mass) containing a resin neutralized with an alkali, such as sodium hydroxide or potassium hydroxide, equivalent to its acid value is prepared. Subsequently, the prepared liquid is diluted 10 times (on a volume basis) with pure water to prepare a sample solution. Then, in the case where the particle size of the resin in the sample solution is measured by the dynamic light scattering method and where a particle having a particle size is not measured, the resin can be determined to be water-soluble. The measurement conditions at this time can be as follows: for example, SetZero: 30 seconds; the number of times of measurement: 3 times; and measurement time: 180 seconds. A particle size analyzer based on the dynamic light scattering method (e.g., trade name: “UPA-EX150”, manufactured by Nikkiso Co., Ltd.) or the like may be used as a particle size distribution measurement apparatus. Of course, the particle size distribution measurement apparatus, the measurement conditions and so forth are not limited to the foregoing.

The acid value of the water-soluble resin can be 100 mgKOH/g or more to 250 mgKOH/g or less. The weight-average molecular weight of the water-soluble resin can be 3,000 or more to 15,000 or less.

The acid value of the resin constituting the resin particle can be 5 mgKOH/g or more to 100 mgKOH/g or less. The weight-average molecular weight of the resin constituting the resin particle is preferably 1,000 or more to 3,000,000 or less, more preferably 100,000 or more to 3,000,000 or less. The 50% cumulative particle size (D₅₀) of the resin particle measured by a dynamic light scattering method on a volume basis can be 50 nm or more to 500 nm or less. The 50% cumulative particle size of the resin particle on a volume basis is a diameter of a particle at which the cumulative value from the small particle size side reaches 50% based on the total volume of the measured particle in a particle size cumulative curve. The 50% cumulative particle size of the resin particle on a volume basis can be measured based on the particle size analyzer and the measurement conditions by the dynamic light scattering method described above. The glass transition temperature of the resin particle is preferably 40° C. or higher to 120° C. or lower, more preferably 50° C. or higher to 100° C. or lower. The glass transition temperature (° C.) of the resin particle can be measured with a differential scanning calorimeter (DSC). The resin particle does not need to contain a coloring material.

### Wax Particle

The ink may contain a particle composed of wax (wax particle). The use of the ink containing the wax particle can record an image having further improved abrasion resistance. The wax in the present specification may be a composition in which a component other than the wax is blended, or may be the wax itself. The wax particle may be dispersed by a dispersant, such as a surfactant or a resin. One type of wax may be used alone, or two or more types of waxes may be used in combination. The wax particle content (% by mass) of the ink is preferably 0.1% by mass or more to 10.0% by mass or less, more preferably 1.0% by mass or more to 5.0% by mass or less, based on the total mass of the ink.

In a narrow sense, the wax is an ester of a fatty acid with a higher monohydric alcohol or dihydric alcohol insoluble in water, and includes an animal wax and a vegetable wax but includes no oil or fat. In a broad sense, the wax includes a high-melting-point fat, a mineral-based wax, a petroleum-based wax and a blend and a modified product of various waxes. According to an embodiment of the present invention, any wax in a broad sense can be used without particular limitation. The wax in a broad sense can be classified into natural wax, synthetic wax, a blend thereof (blended wax) and a modified product thereof (modified wax).

Examples of the natural wax include animal-based wax, such as beeswax, spermaceti, or wool wax (lanolin); plant-based wax, such as Japan wax, carnauba wax, sugarcane wax, palm wax, candelilla wax, or rice wax; mineral-based wax, such as montan wax; and petroleum-based wax, such as paraffin wax, microcrystalline wax and petrolatum. Examples of the synthetic wax include hydrocarbon wax, such as Fischer-Tropsch wax and polyolefin wax, e.g., polyethylene wax and polypropylene wax. The blended wax is a mixture of the various waxes described above. The modified wax is prepared by subjecting the above-described various waxes to modification treatment, such as oxidation, hydrogenation, alcohol modification, acrylic modification or urethane modification. These waxes may be used alone or in combination of two or more. The wax can be at least one selected from the group consisting of microcrystalline wax, Fischer-Tropsch wax, polyolefin wax, paraffin wax, modified products thereof and blends thereof. Among these, a blend of a plurality of waxes can be used. A blend of petroleum-based wax and synthetic wax can be used.

The wax can be solid at room temperature (25° C.). The melting point (° C.) of the wax is preferably 40° C. or higher to 120° C. or lower, more preferably 50° C. or higher to 100° C. or lower. The melting temperature of the wax can be determined in accordance with a test method described in 5.3.1 (testing method for melting point) of JIS K 2235:1991 (petroleum waxes). For microcrystalline wax, petrolatum and a mixture of a plurality of waxes, the melting point can be more accurately measured by a test method described in 5.3.2. The melting point of the wax is easily affected by properties, such as molecular weight (a higher molecular weight results in a higher melting point), molecular structure (a linear structure has a high melting point, and a branched structure has a lower melting point), crystallinity (a high crystallinity results in a higher melting point) and density (a higher density results in a higher melting point). Thus, wax having a desired melting point can be produced by controlling these properties. The melting point of the wax in the ink can be determined by, for example, subjecting the ink to ultracentrifugation treatment, washing and drying the separated wax, and then performing measurement in accordance with the above-described test method.

### Aqueous Medium

The ink used in the recording method according to an embodiment of the present invention is an aqueous ink containing at least water as the aqueous medium. The ink can contain water or an aqueous medium that is a mixed solvent of water and a water-soluble organic solvent. Deionized water or ion-exchanged water can be used as the water. The water content (% by mass) of the aqueous ink can be 50.0% by mass or more to 95.0% by mass or less based on the total mass of the ink. The water-soluble organic solvent content (% by mass) of the aqueous ink can be 2.0% by mass or more to 40.0% by mass or less based on the total mass of the ink. Examples of the water-soluble organic solvent include alcohol, (poly)alkylene glycol, glycol ether, a nitrogen-containing solvent and a sulfur-containing solvent, which can be used in an ink for ink jet recording. These water-soluble organic solvents may be used alone or in combination of two or more.

### Water-Soluble Hydrocarbon Compound

The water-soluble organic solvent incorporated into the ink can contain a specific water-soluble hydrocarbon compound. This water-soluble hydrocarbon compound is a compound that has a hydrocarbon chain having 3 or more carbon atoms and that is substituted with 2 or more hydrophilic groups selected from the group consisting of a hydroxy group, an amino group and an anionic group. However, the hydrocarbon chain may be interrupted by a sulfonyl group or an ether group. When the hydrocarbon chain has 3 or 4 carbon atoms, the hydrophilic group contains an anionic group or the hydrocarbon chain is interrupted by a sulfonyl group.

In an embodiment of the present invention, a hydrocarbon compound in the state of being dissolved in water at a compound content of the ink at 25° C. is defined as being “water-soluble”. That is, the solubility of the compound in water at 25° C. is larger than the compound content of the ink. The fact that the hydrocarbon chain is interrupted by a sulfonyl group or an ether group indicates that a sulfonyl group (—S(═O)₂—) or an ether group (—O—) is present in the middle of the hydrocarbon chain. The water-soluble hydrocarbon compound has a hydrogen-bonding group, such as a hydroxy group, an amino group, an anionic group, a sulfonyl group or an ether group. For this reason, the use of the ink containing the hydrocarbon compound can inhibit the cockling or curl of a recording medium on which an image has been recorded. A typical hydrocarbon compound having a hydrocarbon chain having a relatively small number of carbon atoms (3 or 4 carbon atoms) has a small molecular weight and tends to have a low vapor pressure. However, since the above-mentioned water-soluble hydrocarbon compound has a hydrogen-bonding anionic group or its hydrocarbon chain is interrupted by a sulfonyl group, the compound is less likely to evaporate owing to an intermolecular or intramolecular interaction and thus remains between fibers to provide the effect of inhibiting the cockling or curl. The water-soluble hydrocarbon compound content (% by mass) of the ink can be 1.0% by mass or more to 20.0% by mass or less based on the total mass of the ink.

The number of the carbon atoms of the hydrocarbon chain constituting the water-soluble hydrocarbon compound is preferably 3 or more to 50 or less, more preferably 3 or more to 10 or less. Examples of the anionic group include a sulfonic acid group and a carboxylic acid group. Specific examples of the water-soluble hydrocarbon compound include alkanediols, such as 1,5-pentanediol and 1,6-hexanediol; amino acids, such as alanine, β-alanine, trimethylglycine, amidosulfuric acid (alias: sulfamic acid), aminomethanesulfonic acid, taurine (synonym: 2-aminoethanesulfonic acid), carbamic acid, glycine, aspartic acid, glutamic acid, sulfanilic acid, salts of the acids described above, phenylalanine, leucine, isoleucine, threonine, tryptophan, valine, methionine, lysine and arginine; sulfonyl compounds, such as bis(2-hydroxyethyl)sulfone; alkylene glycols, such as triethylene glycol, tetraethylene glycol, tripropylene glycol and a polyethylene glycol having a number-average molecular weight of about 200 or more to about 1,000 or less; and sugars, such as sorbitol, D-sorbitol, xylitol, trehalose, fructose and D(+)-xylose. These water-soluble hydrocarbon compounds may be used alone or in combination two or more.

### Other Components

The ink may contain various other components as needed. Examples of the other components include various additives, such as a defoaming agent, a surfactant, a pH adjuster, a viscosity modifier, a rust inhibitor, a preservative, an antifungal agent, an antioxidant, and a reduction inhibitor. However, the ink need not contain the reactant contained in the reaction liquid.

### Physical Properties of Ink

The ink is an aqueous ink for use in the ink jet method. Thus, from the viewpoint of reliability, the physical property values can be appropriately controlled. The surface tension of the ink at 25° C. can be 20 mN/m or more to 60 mN/m or less. The viscosity of the ink at 25° C. can be 1.0 mPa·s or more to 10.0 mPa·s or less. The pH of the ink at 25° C. is preferably 7.0 or more to 9.5 or less, more preferably 8.0 or more to 9.5 or less.

### EXAMPLES

While the present invention will be described in more detail with reference to examples and comparative examples, the present invention is not limited at all by the following examples as long as the gist of the present invention is not exceeded. Regarding the amount of component, “part(s)” and “%” are based on mass unless otherwise specified.

### Preparation of Pigment Dispersion Liquid

### Pigment Dispersion Liquid 1

A solution prepared by dissolving 5.0 g of concentrated hydrochloric acid in 5.5 g of water was cooled to 5° C., and in this state, 1.8 g of 4-amino-1,2-benzenedicarboxylic acid was added thereto. The container containing this solution was placed in an ice bath, and while the temperature of the solution was maintained at 10° C. or lower under stirring, a solution prepared by dissolving 1.8 g of sodium nitrite in 9.0 g of ion-exchanged water at 5° C. was added thereto. After stirring for 15 minutes, 6.0 g of carbon black (BET specific surface area: 254 m²/g, dibutyl phthalate (DBP) oil absorption: 180 mL/100 g) was added under stirring. The mixture was stirred for another 15 minutes to prepare a slurry. The resulting slurry was filtered through filter paper (trade name: “Standard filter paper No. 2”, manufactured by Toyo Roshi Kaisha, Ltd.). The resulting particle was sufficiently washed with water and dried in an oven at 110° C. An appropriate amount of ion-exchanged water was added to adjust the pigment content (carbon black), preparing pigment dispersion liquid 1 having a pigment content of 10.0%. The resulting pigment dispersion liquid 1 contained a self-dispersible pigment having a —C₆H₃—(COONa)₂ group bonded to the surface of the pigment particle (carbon black).

### Pigment Dispersion Liquid 2

A styrene-ethyl acrylate-acrylic acid copolymer (resin 1) having an acid value of 150 mgKOH/g and a weight-average molecular weight of 8,000 was provided. Then 20.0 parts of resin 1 was neutralized with potassium hydroxide in an amount equimolar to the acid value thereof. An appropriate amount of pure water was added thereto to prepare an aqueous solution of resin 1 having a resin content (solid content) of 20.0%. A mixture was prepared by mixing 10.0 parts of a pigment (carbon black), 15.0 parts of the aqueous solution of resin 1 and 75.0 parts of pure water. The resulting mixture and 200 parts of a zirconia bead having a diameter of 0.3 mm were placed in a batch-type vertical sand mill (manufactured by Aimex Co., Ltd.) and dispersed for 5 hours while the sand mill was cooled with water. After a coarse particle was removed by centrifugation, pressure filtration was performed with a cellulose acetate filter (manufactured by Toyo Roshi Kaisha, Ltd.) having a pore size of 3.0 μm to prepare pigment dispersion liquid 2 having a pigment content of 10.0% and a resin dispersant (resin 1) content of 3.0%.

### Pigment Dispersion Liquid 3

Pigment dispersion liquid 3 having a pigment content of 10.0% and a resin dispersant (resin 1) content of 3.0% was prepared by the same procedure as that for pigment dispersion liquid 1, except that the pigment was changed to C.I. Pigment Blue 15:3.

### Pigment Dispersion Liquid 4

Pigment dispersion liquid 4 having a pigment content of 10.0% and a resin dispersant (resin 1) content of 3.0% was prepared by the same procedure as that for pigment dispersion liquid 1, except that the pigment was changed to C.I. Pigment Red 122.

### Pigment Dispersion Liquid 5

Pigment dispersion liquid 5 having a pigment content of 10.0% and a resin dispersant (resin 1) content of 3.0% was prepared by the same procedure as that for pigment dispersion liquid 1, except that the pigment was changed to C.I. Pigment Yellow 74.

### Pigment Dispersion Liquid 6

A mixture was prepared by mixing 30.0 parts of a pigment, 4.0 parts of a dispersant, 0.2 parts of a defoamer (trade name: Surfynol 104E, manufactured by Nissin Chemical Industry Co., Ltd.) and 70.8 parts of ion-exchanged water. As the dispersant, a nonionic surfactant (trade name: “NIKKOL BC-20”, polyoxyethylene cetyl ether) was used. As the pigment, carbon black (trade name: “MCF #1000”, manufactured by Mitsubishi Chemical Corporation) was used. The resulting mixture was placed in a paint shaker (manufactured by Toyo Seiki Seisaku-sho, Ltd.) containing a zirconia bead having a diameter of 0.3 mm, and subjected to dispersion treatment for 60 minutes to prepare pigment dispersion liquid 6 having a pigment content of 30.0% and a dispersant (surfactant) content of 4.0%.

### Preparation of Aqueous Dye Solution

A dye (C.I. Direct Blue 199) was dissolved in pure water, and then excess acid was added to precipitate the dye. The precipitated dye was separated by filtration to give a wet cake of the dye having an anionic group in an acid form. The resulting wet cake was added to pure water. An aqueous solution of sodium hydroxide in an amount equimolar to the anionic group of the dye was added to neutralize the anionic group, thereby dissolving the dye. An appropriate amount of pure water was further added to prepare aqueous dye solution 1 having a dye content of 10.0%.

### Preparation of Resin Particle

### 50% Cumulative Particle Size of Resin Particle on Volume Basis

An aqueous dispersion of a resin particle was diluted with pure water to prepare a resin particle-containing liquid having a resin particle content of 1.0% as a measurement sample. The 50% cumulative particle size (D₅₀ (nm)) of a resin particle on a volume basis in the measurement sample was measured using a particle size distribution measurement apparatus (trade name: Nanotrac UPA-EX150, manufactured by Nikkiso Co., Ltd.) based on a dynamic light scattering method. The measurement conditions were as follows: SetZero: 30 seconds, the number of measurements: 3, measurement time: 180 seconds, shape: true sphere and refractive index: 1.6.

### Glass Transition Temperature of Resin Particle

A resin obtained by drying the aqueous dispersion of the resin particle was prepared as a sample. A temperature increase cycle in which the temperature was increased from −70° C. to 180° C. at a rate of 10° C./min was performed twice with a differential scanning calorimeter (trade name “Q200”, manufactured by TA Instruments) to measure the glass transition temperature (Tg (° C.)) of the resin particle.

### Resin Particle 1

A solution was prepared by mixing 0.2 parts of potassium persulfate and 74.0 parts of ion-exchanged water. An emulsion was prepared by mixing 19.0 parts of ethyl methacrylate, 5.0 parts of n-butyl methacrylate, 1.5 parts of methacrylic acid and 0.3 parts of a reactive surfactant. As the reactive surfactant, a nonionic surfactant (trade name “Adeka Reasoap ER20”, manufactured by Adeka Corporation, the number of ethylene oxide groups: 20) was used. The emulsion was added dropwise to the solution over one hour under a nitrogen atmosphere, and polymerization was carried out under stirring at 80° C., followed by stirring for another two hours. After the mixture was cooled to room temperature, ion-exchanged water and an aqueous solution of potassium hydroxide were added to prepare an aqueous dispersion liquid of resin particle 1 having a resin particle content of 25.0%. Resin particle 1 had a 50% cumulative particle size (D₅₀) of 100 nm on a volume basis and a glass transition temperature (Tg) of 60° C., where D₅₀ and Tg were measured by the methods described above.

### Resin Particle 2

An aqueous dispersion liquid of a nonionic resin particle (trade name: “Vinyblan 1225”, manufactured by Nissin Chemical Industry Co., Ltd., vinyl acetate-acrylic resin-based resin particle, resin particle content: 45.0%) was diluted with ion-exchanged water to prepare an aqueous dispersion liquid of resin particle 2 having a resin particle 2 content of 25.0%. Resin particle 2 had a 50% cumulative particle size (D₅₀) of 100 nm on a volume basis and a glass transition temperature (Tg) of 9° C.

### Preparation of Water-Soluble Resin

### Water-Soluble Resin 1

First, 20.0 parts of a styrene-acrylic acid copolymer (water-soluble resin 1) synthesized in the usual manner was dissolved in ion-exchanged water using sodium hydroxide in an amount equimolar to the acid value to prepare an aqueous solution. Water-soluble resin 1 had a weight-average molecular weight of 8,000 and an acid value of 120 mgKOH/g. The resulting aqueous solution was pressure-filtered through a microfilter (manufactured by Fujifilm Corporation) having a pore size of 3.0 m. Ion-exchanged water was added to adjust the resin content, resulting in an aqueous solution of water-soluble resin 1 having a resin content of 20.0%.

### Water-Soluble Resin 2

A four-necked flask equipped with a stirrer, a thermometer, a nitrogen gas inlet and a reflux condenser was provided. In the four-necked flask, 34.5 parts of isophorone diisocyanate and 49.8 parts of polypropylene glycol (number-average molecular weight: 2,000) were placed. The mixture was reacted at 100° C. for 2 hours under a nitrogen gas atmosphere. Then, 0.3 parts of ethylenediamine, 14.1 parts of dimethylolpropionic acid and 150.0 parts of methyl ethyl ketone were added thereto. Then, the residual ratio of the isocyanate group was confirmed by FT-IR, and the reaction was carried out at 78° C. until a desired residual ratio was obtained. Further, 1.3 parts of methanol and 300.0 parts of ion-exchanged water were added thereto to obtain a reaction solution. After the reaction solution was cooled to 40° C., ion-exchanged water was added. A neutralizing agent (potassium hydroxide) was added to the mixture while the mixture was stirred at high speed with a homomixer. Methyl ethyl ketone was distilled off by heating under reduced pressure to give an aqueous solution of water-soluble resin 2 with a urethane resin (water-soluble resin 2) content of 20.0%. Water-soluble resin 2 had a weight-average molecular weight of 12,000 and an acid value of 59 mgKOH/g.

### Preparation of Liquid Composition

Components (unit: %) given in Table 1 were mixed. The resulting mixtures were sufficiently stirred and pressure-filtered through cellulose acetate filters (manufactured by Toyo Roshi Kaisha, Ltd.) having a pore size of 3.0 m to prepare respective liquid compositions. The numerical value attached to polyethylene glycol represents the number-average molecular weight. Details of the trade names in Table 1 are described below. The conductivity of each of the prepared liquid compositions at 25° C. was measured with a conductivity meter (trade name: “ES-51”, manufactured by Horiba Ltd.). The measurement results are presented in Table 1.
PAA08: Cationic polymer, manufactured by Nitto Boseki Co., Ltd.
Acetylenol E100: Nonionic surfactant (ethylene oxide adduct of acetylene glycol), manufactured by Kawaken Fine Chemicals Co., Ltd.
NIKKOL BC-20: Nonionic surfactant (polyoxyethylene cetyl ether), manufactured by Nikko Chemicals Co., Ltd., HLB value: 17.0, number of carbon atoms: 16
Pluronic (registered trademark) L31: Nonionic surfactant (triblock copolymer of ethylene oxide and propylene oxide), manufactured by Adeka Corporation
Silface SAG005: Nonionic surfactant (polyether-modified siloxane compound), manufactured by Nissin Chemical Industry Co., Ltd.

TABLE 1
Composition and characteristics of liquid compositions

| | Liquid composition | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| Pigment dispersion | 30.0 | 30.0 | 30.0 | 30.0 | | | | | 30.0 | 30.0 | 30.0 | | | 30.0 | 15.0 |
| liquid 1 | | | | | | | | | | | | | | | |
| Pigment dispersion | | | | | 30.0 | | | | | | | | | | |
| liquid 2 | | | | | | | | | | | | | | | |
| Pigment dispersion | | | | | | 30.0 | | | | | | | | | |
| liquid 3 | | | | | | | | | | | | | | | |
| Pigment dispersion | | | | | | | 30.0 | | | | | | | | |
| liquid 4 | | | | | | | | | | | | | | | |
| Pigment dispersion | | | | | | | | 30.0 | | | | | | | |
| liquid 5 | | | | | | | | | | | | | | | |
| Pigment dispersion | | | | | | | | | | | | 10.0 | | | |
| liquid 6 | | | | | | | | | | | | | | | |
| Aqueous dye | | | | | | | | | | | | | | | |
| solution 1 | | | | | | | | | | | | | | | |
| Aqueous dispersion | 10.0 | 10.0 | 10.0 | 10.0 | 10.0 | 10.0 | 10.0 | 10.0 | 10.0 | 10.0 | 10.0 | | 10.0 | | 5.0 |
| liquid of resin | | | | | | | | | | | | | | | |
| particle 1 | | | | | | | | | | | | | | | |
| Aqueous dispersion | | | | | | | | | | | | | | 10.0 | |
| liquid of resin | | | | | | | | | | | | | | | |
| particle 2 | | | | | | | | | | | | | | | |
| Aqueous solution | | | | | | | | | | | | | | | |
| of water-soluble | | | | | | | | | | | | | | | |
| resin 1 | | | | | | | | | | | | | | | |
| Aqueous solution | | | | | | | | | | | | | | | |
| of water-soluble | | | | | | | | | | | | | | | |
| resin 2 | | | | | | | | | | | | | | | |
| Magnesium | | | | | | | | | | | | | | | |
| sulfate | | | | | | | | | | | | | | | |
| Calcium | | | | | | | | | | | | | | | |
| chloride | | | | | | | | | | | | | | | |
| PAA08 | | | | | | | | | | | | | | | |
| Glycerin | 15.0 | | | | 15.0 | 15.0 | 15.0 | 15.0 | 15.0 | 15.0 | 15.0 | 15.0 | 15.0 | 15.0 | 15.0 |
| Ethylene | | 15.0 | | | | | | | | | | | | | |
| glycol | | | | | | | | | | | | | | | |
| 1,3-Butanediol | | | 15.0 | | | | | | | | | | | | |
| Polyethylene | | | | 15.0 | | | | | | | | | | | |
| glycol 200 | | | | | | | | | | | | | | | |
| Acetylenol E100 | 1.0 | 1.0 | 1.0 | 1.0 | 1.0 | 1.0 | 1.0 | 1.0 | | | | 1.0 | 1.0 | 1.0 | 1.0 |
| NIKKOL BC-20 | | | | | | | | | 1.0 | | | | | | |
| Pluronic L31 | | | | | | | | | | 1.0 | | | | | |
| Sliface SAG006 | | | | | | | | | | | 1.0 | | | | |
| Sodium | | | | | | | | | | | | 0.5 | | | |
| 1-hexanesulfonate | | | | | | | | | | | | | | | |
| Sodium | | | | | | | | | | | | | | | |
| dodecylbenzenesulfonate | | | | | | | | | | | | | | | |
| Ion-exchanged water | 44.0 | 44.0 | 44.0 | 44.0 | 44.0 | 44.0 | 44.0 | 44.0 | 44.0 | 44.0 | 44.0 | 73.5 | 74.0 | 44.0 | 64.0 |
| Conductivity (μS/cm) | 200 | 200 | 200 | 200 | 200 | 200 | 200 | 200 | 200 | 200 | 200 | 10 | 10 | 190 | 100 |

| | Liquid composition | | | | | | | | | | | | | |
|---|---|---|---|---|---|---|---|---|---|---|---|---|---|---|
| | 16 | 17 | 18 | 19 | 20 | 21 | 22 | 23 | 24 | 25 | 26 | 27 | 28 | 29 |
| Pigment dispersion | 15.0 | | 30.0 | 30.0 | | | | | | | 30.0 | 30.0 | | |
| liquid 1 | | | | | | | | | | | | | | |
| Pigment dispersion | | | | | | | | | | | | | | |
| liquid 2 | | | | | | | | | | | | | | |
| Pigment dispersion | | | | | | | | | | | | | | |
| liquid 3 | | | | | | | | | | | | | | |
| Pigment dispersion | | | | | | | | | | | | | | |
| liquid 4 | | | | | | | | | | | | | | |
| Pigment dispersion | | | | | | | | | | | | | | |
| liquid 5 | | | | | | | | | | | | | | |
| Pigment dispersion | | | | | | | | | | | | | 10.0 | |
| liquid 6 | | | | | | | | | | | | | | |
| Aqueous dye | 48.0 | 30.0 | | | | | | | 1.5 | | | | | |
| solution 1 | | | | | | | | | | | | | | |
| Aqueous dispersion | 10.0 | 10.0 | | | | | | | | | 10.0 | 10.0 | | 4.0 |
| liquid of resin | | | | | | | | | | | | | | |
| particle 1 | | | | | | | | | | | | | | |
| Aqueous dispersion | | | | | | | | | | 4.0 | | | | |
| liquid of resin | | | | | | | | | | | | | | |
| particle 2 | | | | | | | | | | | | | | |
| Aqueous solution | | | 12.5 | | | | | | 4.0 | | | | | |
| of water-soluble | | | | | | | | | | | | | | |
| resin 1 | | | | | | | | | | | | | | |
| Aqueous solution | | | | 12.5 | | | | | | | | | | |
| of water-soluble | | | | | | | | | | | | | | |
| resin 2 | | | | | | | | | | | | | | |
| Magnesium | | | | | 10.0 | 10.0 | | | | | | | | |
| sulfate | | | | | | | | | | | | | | |
| Calcium | | | | | | | 10.0 | | | | | | | |
| chloride | | | | | | | | | | | | | | |
| PAA08 | | | | | | 10.0 | | 30.0 | | | | | | |
| Glycerin | 15.0 | 15.0 | 15.0 | 15.0 | 15.0 | 15.0 | 15.0 | 15.0 | 15.0 | 15.0 | 15.0 | 15.0 | 15.0 | 15.0 |
| Ethylene | | | | | | | | | | | | | | |
| glycol | | | | | | | | | | | | | | |
| 1,3-Butanediol | | | | | | | | | | | | | | |
| Polyethylene | | | | | | | | | | | | | | |
| glycol 200 | | | | | | | | | | | | | | |
| Acetylenol E100 | 1.0 | 1.0 | 1.0 | 1.0 | 1.0 | 1.0 | 1.0 | 1.0 | 1.0 | 10 | | | 1.0 | 1.0 |
| NIKKOL BC-20 | | | | | | | | | | | | | | |
| Pluronic L31 | | | | | | | | | | | | | | |
| Sliface SAG006 | | | | | | | | | | | | | | |
| Sodium | | | | | | | | | | | 1.0 | | 0.2 | |
| 1-hexanesulfonate | | | | | | | | | | | | | | |
| Sodium | | | | | | | | | | | | 1.0 | | |
| dodecylbenzenesulfonate | | | | | | | | | | | | | | |
| Ion-exchanged water | 11.0 | 44.0 | 41.5 | 41.5 | 74.0 | 64.0 | 74.0 | 54.0 | 78.5 | 80.0 | 44.0 | 44.0 | 73.8 | 80.0 |
| Conductivity (μS/cm) | 2985 | 1810 | 200 | 195 | 400 | 500 | 600 | 300 | 93 | 0 | 220 | 220 | 4 | 4 |

### Preparation of Recording Head

Liquid ejection heads 1 to 4, which are liquid applying devices having the configuration illustrated in FIG. 2, were produced with reference to the description in Japanese Patent Laid-Open No. 2009-051146. Regarding the constituent materials of the second protective layers, iridium was used in the liquid ejection heads 1 and 4. Ruthenium was used in the liquid ejection head 2. Tantalum was used in the liquid ejection head 3. Each of the liquid ejection heads presented in Table 2 was mounted on an ink jet recording apparatus having the configuration illustrated in FIG. 1. Liquid compositions 1 to 29 presented in Table 2 were each filled into the ink jet recording apparatus.

In Examples 1 to 31 and 36 and Comparative Examples 1 to 7, 9 and 10, voltage control was performed in such a manner that the heater side region 107a of each second protective layer was negatively charged and the counter electrode side region 107b was positively charged (FIGS. 4 and 5). Specifically, a DC voltage corresponding to the absolute value of the voltage Eb (V) presented in Table 2 was started to be applied to the external electrode 111 connected to the heater side region 107a of the second protective layer (step S2). In Table 2, the voltage Eb (V) column presents a numerical values marked with “+” to indicate the voltage applied to the external electrode 111. However, the heater side region of the second protective layer was negatively charged. In Examples 32 to 35, voltage control was performed in such a manner that the heater side region 107a of each second protective layer was positively charged and the counter electrode side region 107b was negatively charged. Specifically, a DC voltage corresponding to the absolute value of the voltage Eb (V) presented in Table 2 was started to be applied to the external electrode 111 connected to the heater side region 107a of the second protective layer (step S2). In Table 2, the voltage Eb (V) column presents numerical values marked with “−” to indicate the voltage applied to the external electrode 111. However, the heater side region 107a of the second protective layer was positively charged. In Comparative Examples 8 and 11 to 13, a DC voltage was not applied to the external electrode 111 connected to the heater side region 107a and the counter electrode side region 107b.

As illustrated in FIG. 7, each of recording heads 1 to 3 has a circulation flow path through which the liquid composition circulates from the sub tank 1503 to the liquid applying device 1200 (recording head) via the liquid chamber 1508. The recording head 4 does not have a circulation flow path passing through the liquid chamber 1508, but only has a circulation flow path through which the ink circulates between the connection portion (inflow portion) 1507 and the connection portion (outflow portion) 1507. For each recording head, the flow rate of the liquid composition in the circulation flow path was controlled by adjusting the pressure using the negative pressure control unit 1509 illustrated in FIG. 7.

### Detector

When evaluations described below were performed, images were recorded by ejecting the liquid composition while the detection (indicated as “Leakage” and “Remaining amount” in the target column of Table 2) was performed as described below. In Examples 1 to 36 and Comparative Examples 1, 6, 8, 9 and 12, a pair of electrode pins was used to detect the state of each liquid composition. In Examples 1 to 14 and 16 to 36 and Comparative Examples 1 to 6, 8, 9 and 12, a pair of electrode pins 214a and 214b provided at the connection portion (inflow portion) 1507 illustrated in FIG. 7 was used, and a control board connected to the electrode pins was operated. A voltage Ea (V) presented in Table 2 was applied to the electrode pin 214a, and leakage of the liquid composition was detected from the potential difference between the electrode pins. In Comparative Examples 7, 10, 11 and 13, the state of each liquid composition was detected using an optical sensor provided at the connection portion (inflow portion) illustrated in FIG. 7. In Example 15, a pair of electrode pins 213a and 213b provided in the sub tank 1503 illustrated in FIG. 7 was used, and a control board connected to the electrode pins was operated. A voltage Ea (V) presented in Table 2 was applied to the electrode pin 213a, and the amount of the remaining liquid composition was detected from the potential difference between the electrode pins.

### Evaluations

The following evaluations were performed using the ink jet recording apparatus with the configuration illustrated in FIG. 1. In the examples, the recording duty of an image recorded in such a manner that the amount of the liquid composition applied is 8 g/m2, is defined as 100%. In the examples of the present invention, “A” and “B” were defined as acceptable levels, and “C” was defined as an unacceptable level in the evaluation criteria described below. The evaluation results are presented in Table 2.

### Continuous Ejection Stability

An ink jet recording apparatus equipped with a recording head of the type presented in Table 2 was used, and a voltage for ejecting the liquid composition was applied to the heat-generating part 104a while a voltage-controlled state was maintained (FIG. 5 and step S3 in FIG. 6). Specifically, a driving pulse having a voltage of 20.0 V and a pulse width of 1.5 μsec was applied 1.5×10⁸ times to the heat-generating part 104a at a frequency of 0.5 kHz to eject the liquid composition. These ejection conditions are assumed to be conditions at a level that would cause kogation on the liquid ejection heater if voltage control was not performed.

After the above-mentioned continuous ejection, solid images with recording duties of 100% and 60% were recorded on glossy paper (trade name: “Canon Photo Paper Glossy Gold”, manufactured by CANON KABUSHIKI KAISHA). Since the liquid compositions used in Examples 13, 32 to 35 and Comparative Examples 1 and 5 contained no coloring material. Thus, similar solid images were recorded on OHP transparencies (trade name: “KOKUYO OHP Film VF-1420N”, manufactured by Kokuyo Co., Ltd.) so that the recorded images could be easily confirmed. After recording was completed (step S4), the voltage control was stopped (step S5). The state of unevenness in each recorded image was visually confirmed, and the continuous ejection stability was evaluated according to the following evaluation criteria.
A: No unevenness occurred in any of the solid images.
B: Unevenness occurred in the solid image with a recording duty of 100%, but no unevenness occurred in the solid image with a recording duty of 60%.
C: Unevenness occurred in all solid images.

### Detection Accuracy

After the above-mentioned evaluation of the continuous ejection stability was performed, whether a deterioration in detection accuracy over time was inhibited was evaluated by the following procedure in a simulated manner using the ink in the device. Specifically, the ink was extracted from the sub tank 1503 and placed in a beaker. A pair of electrode pins similar to the pair of electrode pins 213a and 213b was immersed in the ink from the bottom thereof to a predetermined length. A current was passed through the pair of electrode pins to measure whether a potential difference was detected. The liquid composition was brought into contact with the electrodes under the following conditions to evaluate the detection accuracy. When the detection accuracy is reduced, it is difficult to detect the potential difference even if the portions in contact with the electrode pins are long. Thus, the fact that the potential difference is detected even if the immersion portions of the electrode pins are short indicates excellent detection accuracy. When the detection target is a leakage of a liquid composition, if no potential difference is detected despite the leakage, it can be mistaken that no leakage has occurred. Thus, if the detection accuracy of the following method is excellent, leakage can be detected with high accuracy.
A: A potential difference was detected even when only 25% of the length from the bottom of each electrode pin was immersed in the liquid composition.
B: No potential difference was detected when only 25% of the length of the electrode pin from the bottom of each electrode pin was immersed in the liquid composition, but a potential difference was detected when 50% of the length from the bottom of each electrode pin was immersed in the liquid composition.
C: No potential difference was detected when 50% of the length from the bottom of each electrode pin was immersed in the liquid composition.

### Intermittent Ejection Stability

An ink jet recording apparatus equipped with a recording head of the type presented in Table 2 was used, and a driving pulse having a voltage of 20.0 V, a pulse width of 1.5 μsec and a frequency of 0.5 kHz was applied to the heat-generating part 104a to perform one ejection operation. Then, after a predetermined suspension time, a solid image was recorded on glossy paper (product name: “Canon Photo Paper Glossy Gold”, manufactured by CANON KABUSHIKI KAISHA) with a recording duty of 100%. Since the liquid compositions used in Examples 13, 32 to 35 and Comparative Examples 1 and 5 contained no coloring material. Thus, similar solid images were recorded on OHP transparencies (trade name: “KOKUYO OHP Film VF-1420N”, manufactured by Kokuyo Co., Ltd.) so that the recorded images could be easily confirmed. The recorded image was observed, and the intermittent ejection stability was evaluated according to the following evaluation criteria. When no unevenness occurs in the image even after a long suspension time, it indicates excellent intermittent ejection stability.
A: No unevenness was observed in the image even at a suspension time of 10 seconds.
B: Unevenness was observed in the image at a suspension time of 10 seconds, but no unevenness was observed in the image at a suspension time of 5 seconds.
C: Unevenness was observed in the image at a suspension time of 5 seconds.

TABLE 2
Evaluation conditions and evaluation results

| | | Evaluation conditions | | | | | | | | | |
|---|---|---|---|---|---|---|---|---|---|---|---|
| | | | Liquid ejection head | | | | | | | | |
| | | | | | Circulation | | | | Evaluation results | | |
| | | | | | flow rate | Detector | | | Continuous | | Intermittent |
| | | Liquid | | Voltage | (velocity) | | | Voltage | ejection | Detection | ejection |
| | | composition | Type | Eb (V) | (mm/s) | Type | Target | Ea (V) | stability | accuracy | stability |
| Example | 1 | 1 | 1 | +2.0 | 1.0 | Electrode | Leakage | 3.0 | A | A | A |
| | | | | | | pin | | | | | |
| | 2 | 2 | 1 | +2.0 | 1.0 | Electrode | Leakage | 3.0 | A | A | A |
| | | | | | | pin | | | | | |
| | 3 | 3 | 1 | +2.0 | 1.0 | Electrode | Leakage | 3.0 | A | A | A |
| | | | | | | pin | | | | | |
| | 4 | 4 | 1 | +2.0 | 1.0 | Electrode | Leakage | 3.0 | A | A | A |
| | | | | | | pin | | | | | |
| | 5 | 5 | 1 | +2.0 | 1.0 | Electrode | Leakage | 3.0 | A | A | A |
| | | | | | | pin | | | | | |
| | 6 | 6 | 1 | +2.0 | 1.0 | Electrode | Leakage | 3.0 | A | A | A |
| | | | | | | pin | | | | | |
| | 7 | 7 | 1 | +2.0 | 1.0 | Electrode | Leakage | 3.0 | A | A | A |
| | | | | | | pin | | | | | |
| | 8 | 8 | 1 | +2.0 | 1.0 | Electrode | Leakage | 3.0 | A | A | A |
| | | | | | | pin | | | | | |
| | 9 | 9 | 1 | +2.0 | 1.0 | Electrode | Leakage | 3.0 | A | A | A |
| | | | | | | pin | | | | | |
| | 10 | 10 | 1 | +2.0 | 1.0 | Electrode | Leakage | 3.0 | A | A | A |
| | | | | | | pin | | | | | |
| | 11 | 11 | 1 | +2.0 | 1.0 | Electrode | Leakage | 3.0 | A | A | A |
| | | | | | | pin | | | | | |
| | 12 | 12 | 1 | +2.0 | 1.0 | Electrode | Leakage | 3.0 | B | B | A |
| | | | | | | pin | | | | | |
| | 13 | 13 | 1 | +2.0 | 1.0 | Electrode | Leakage | 3.0 | B | B | A |
| | | | | | | pin | | | | | |
| | 14 | 14 | 1 | +2.0 | 1.0 | Electrode | Leakage | 3.0 | B | A | A |
| | | | | | | pin | | | | | |
| | 15 | 1 | 1 | +2.0 | 1.0 | Electrode | Remaining | 3.0 | A | A | A |
| | | | | | | pin | amount | | | | |
| | 16 | 1 | 1 | +1.0 | 1.0 | Electrode | Leakage | 3.0 | A | A | A |
| | | | | | | pin | | | | | |
| | 17 | 1 | 1 | +2.4 | 1.0 | Electrode | Leakage | 3.0 | A | A | A |
| | | | | | | pin | | | | | |
| | 18 | 1 | 1 | +2.5 | 1.0 | Electrode | Leakage | 3.0 | B | A | A |
| | | | | | | pin | | | | | |
| | 19 | 1 | 1 | +2.0 | 1.0 | Electrode | Leakage | 4.0 | A | A | A |
| | | | | | | pin | | | | | |
| | 20 | 1 | 1 | +2.0 | 1.0 | Electrode | Leakage | 2.5 | A | A | A |
| | | | | | | pin | | | | | |
| | 21 | 1 | 1 | +2.0 | 1.0 | Electrode | Leakage | 2.0 | A | B | A |
| | | | | | | pin | | | | | |
| | 22 | 15 | 1 | +2.0 | 1.0 | Electrode | Leakage | 3.0 | A | A | A |
| | | | | | | pin | | | | | |
| | 23 | 16 | 1 | +2.0 | 1.0 | Electrode | Leakage | 3.0 | A | A | A |
| | | | | | | pin | | | | | |
| | 24 | 1 | 2 | +2.0 | 1.0 | Electrode | Leakage | 3.0 | A | A | A |
| | | | | | | pin | | | | | |
| | 25 | 1 | 3 | +2.0 | 1.0 | Electrode | Leakage | 3.0 | B | A | A |
| | | | | | | pin | | | | | |
| | 26 | 1 | 1 | +2.0 | 0.05 | Electrode | Leakage | 3.0 | A | B | A |
| | | | | | | pin | | | | | |
| | 27 | 1 | 1 | +2.0 | 0.1 | Electrode | Leakage | 3.0 | A | A | A |
| | | | | | | pin | | | | | |
| | 28 | 1 | 1 | +2.0 | 10.0 | Electrode | Leakage | 3.0 | A | A | A |
| | | | | | | pin | | | | | |
| | 29 | 17 | 1 | +2.0 | 1.0 | Electrode | Leakage | 3.0 | B | A | A |
| | | | | | | pin | | | | | |
| | 30 | 18 | 1 | +2.0 | 1.0 | Electrode | Leakage | 3.0 | A | A | B |
| | | | | | | pin | | | | | |
| | 31 | 19 | 1 | +2.0 | 1.0 | Electrode | Leakage | 3.0 | A | A | B |
| | | | | | | pin | | | | | |
| | 32 | 20 | 1 | −2.0 | 1.0 | Electrode | Leakage | 3.0 | A | A | A |
| | | | | | | pin | | | | | |
| | 33 | 21 | 1 | −2.0 | 1.0 | Electrode | Leakage | 3.0 | A | A | A |
| | | | | | | pin | | | | | |
| | 34 | 22 | 1 | −2.0 | 1.0 | Electrode | Leakage | 3.0 | A | A | A |
| | | | | | | pin | | | | | |
| | 35 | 23 | 1 | −2.0 | 1.0 | Electrode | Leakage | 3.0 | B | A | A |
| | | | | | | pin | | | | | |
| | 36 | 24 | 3 | +2.5 | 0.05 | Electrode | Leakage | 2.0 | B | B | B |
| | | | | | | pin | | | | | |
| Comparative | 1 | 25 | 1 | +2.0 | 1.0 | Electrode | Leakage | 3.0 | C | C | A |
| Example | | | | | | pin | | | | | |
| | 2 | 26 | 1 | +2.0 | 1.0 | Electrode | Leakage | 3.0 | A | C | A |
| | | | | | | pin | | | | | |
| | 3 | 27 | 1 | +2.0 | 1.0 | Electrode | Leakage | 3.0 | A | C | A |
| | | | | | | pin | | | | | |
| | 4 | 28 | 1 | +2.0 | 1.0 | Electrode | Leakage | 3.0 | B | C | A |
| | | | | | | pin | | | | | |
| | 5 | 29 | 1 | +2.0 | 1.0 | Electrode | Leakage | 3.0 | C | C | A |
| | | | | | | pin | | | | | |
| | 6 | 1 | 4 | +2.0 | 0.0 | Electrode | Leakage | 3.0 | A | A | C |
| | | | | | | pin | | | | | |
| | 7 | 1 | 1 | +2.0 | 1.0 | Optical | Leakage | 0.0 | A | C | A |
| | 8 | 1 | 1 | 0.0 | 1.0 | Electrode | Leakage | 3.0 | C | A | A |
| | | | | | | pin | | | | | |
| | 9 | 26 | 4 | +2.0 | 0.0 | Electrode | Leakage | 3.0 | A | A | C |
| | | | | | | pin | | | | | |
| | 10 | 26 | 4 | +2.0 | 0.0 | Optical | Leakage | 0.0 | A | C | C |
| | 11 | 26 | 1 | 0.0 | 1.0 | Optical | Leakage | 0.0 | C | C | A |
| | 12 | 26 | 4 | 0.0 | 0.0 | Electrode | Leakage | 3.0 | C | A | C |
| | | | | | | pin | | | | | |
| | 13 | 1 | 4 | 0.0 | 0.0 | Optical | Leakage | 0.0 | C | C | C |

According to an embodiment of the present invention, it is possible to provide an ink jet recording method that achieves excellent continuous ejection stability and excellent intermittent ejection stability and that allows for the high-accuracy detection of the state of a liquid composition, such as an ink. According to an embodiment of the present invention, it is possible to provide an ink jet recording apparatus for use in the ink jet recording method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-140545, filed Aug. 30, 2023, and Japanese Patent Application No. 2024-134042, filed Aug. 9, 2024, which are hereby incorporated by reference herein in their entirety.

What is claimed is:

1. An ink jet recording method for recording an image on a recording medium using an ink jet recording apparatus that includes:
an aqueous liquid composition,
a storage portion configured to store the liquid composition,
a liquid ejection head configured to eject the liquid composition supplied from the storage portion through a supply system and
a detector configured to detect a state of the liquid composition,
wherein the liquid composition comprises:
(1) a material selected from the group consisting of a coloring material, a resin and a reactant, the material being soluble or dispersible in the liquid composition by action of an ionic group, and
(2) a nonionic surfactant,
the liquid composition has a conductivity of 10 μS/cm or more,
the liquid ejection head includes:
an ejection element substrate including:
an ejection port configured to eject the liquid composition, and
a liquid chamber disposed in the ejection element substrate and being filled with the liquid composition, and
a circulation flow path through which the liquid composition circulates from the storage portion to the liquid ejection head via the liquid chamber,
the detector is configured to detect the state of the liquid composition using electrical conduction between a pair of electrodes disposed in the supply system, and
the ejection element substrate includes:
a heater configured to eject a liquid, the heater being disposed in a flow path through which the liquid composition flows, and the flow path communicating with the ejection port,
a first protective layer disposed at a position corresponding to the heater in the flow path, the first protective layer being configured to block contact between the heater and the liquid composition in the flow path,
a second protective layer containing a metal material, the second protective layer being disposed at a position corresponding to the heater in the flow path and configured to come into contact with the liquid composition and
a unit configured to apply a voltage to enable a portion of the second protective layer to serve as an electrode charged to a polarity identical to a polarity of the material and to enable a portion of the second protective layer electrically conducting through the liquid composition to serve as an electrode charged to a polarity different from the polarity of the material.

2. The ink jet recording method according to claim 1, wherein a relationship Eb<2.5≤Ea is satisfied, where Ea is a voltage (V) applied to one of the pair of electrodes when the detector detects the state of the liquid composition, and Eb is a voltage (V) applied to the second protective layer when the liquid ejection head ejects the liquid composition.

3. The ink jet recording method according to claim 1, wherein the liquid composition has a conductivity of 100 μS/cm or more.

4. The ink jet recording method according to claim 1, wherein the metal material contained in the second protective layer comprises at least one selected from the group consisting of iridium and ruthenium.

5. The ink jet recording method according to claim 1, wherein the liquid composition flowing through the circulation flow path has a circulation flow rate of 0.1 mm/s or more.

6. The ink jet recording method according to claim 1, wherein the coloring material comprises at least one selected from the group consisting of a self-dispersible pigment having an anionic group, and a resin-dispersed pigment dispersed by a resin dispersant having an anionic group.

7. The ink jet recording method according to claim 1, wherein the resin comprises at least one selected from the group consisting of a resin particle containing a resin having an anionic group, and a resin particle dispersed by a dispersant having an anionic group.

8. The ink jet recording method according to claim 1, wherein the reactant comprises a polyvalent metal ion.

9. An ink jet recording apparatus, comprising:
an aqueous liquid composition;
a storage portion configured to store the liquid composition;
a liquid ejection head configured to eject the liquid composition supplied from the storage portion through a supply system; and
a detector configured to detect a state of the liquid composition,
wherein the liquid composition comprises:
(1) a material selected from the group consisting of a coloring material, a resin and a reactant, the material being soluble or dispersible in the liquid composition by action of an ionic group, and
(2) a nonionic surfactant,
the liquid composition has a conductivity of 10 μS/cm or more,
the liquid ejection head includes:
an ejection element substrate including:
an ejection port configured to eject the liquid composition, and
a liquid chamber disposed in the ejection element substrate and being filled with the liquid composition, and
a circulation flow path through which the liquid composition circulates from the storage portion to the liquid ejection head via the liquid chamber,
the detector is configured to detect the state of the liquid composition using electrical conduction between a pair of electrodes disposed in the supply system, and
the ejection element substrate includes:
a heater configured to eject a liquid, the heater being disposed in a flow path through which the liquid composition flows, and the flow path communicating with the ejection port,
a first protective layer disposed at a position corresponding to the heater in the flow path, the first protective layer being configured to block contact between the heater and the liquid composition in the flow path,
a second protective layer containing a metal material, the second protective layer being disposed at a position corresponding to the heater in the flow path and configured to come into contact with the liquid composition and
a unit configured to apply a voltage to enable a portion of the second protective layer to serve as an electrode charged to a polarity identical to a polarity of the material and to enable a portion of the second protective layer electrically conducting through the liquid composition to serve as an electrode charged to a polarity different from the polarity of the material.
